(19) United States
(12) Patent Application Publication
(10) Pub. No.: US 2023/0413808 A1
(43) Pub. Date: Dec. 28, 2023

(54) Bioactive complexes

(71) Applicant: Ceradis Patent B.V., Wageningen (NL)

(72) Inventors: Wilhelmus Maria VAN DER KRIEKEN, Wageningen (NL); Sheron Francisco DE OLIVEIRA, Burscheid (DE)

(21) Appl. No.: 18/038,338

(22) PCT Filed: Nov. 24, 2021
(86) PCT No.: PCT/NL2021/050717

§ 371 Date: May 23, 2023

(30) Foreign Application Priority Data
Nov. 24, 2020 (EP) 20209595.6

(51) Int. Cl. A01N 25/10; A01N 37/38; A01N 57/20; A01N 43/50; A01N 43/22; A01N 47/44; A01N 57/12; A01P 3/00; A01P 7/04; A01P 13/00

(52) U.S. Cl. CPC A01N 25/10; A01N 37/38; A01N 57/20; A01N 43/50; A01N 43/22; A01N 47/44; A01N 57/12; A01P 3/00; A01P 7/04; A01P 13/00

(57) ABSTRACT

The invention relates to a composition comprising a complex, of a polycation and a bioactive ingredient. The invention further relates to a method for producing a composition according to the invention, and to the use of said composition. The invention additionally relates to a method of protecting a plant or soil, and to a method of preventing, reducing and/or eliminating the presence of a pathogen on a plant or in a soil, by contacting said plant or soil with a composition of the invention.

### FIELD

The present invention relates to an agricultural composition comprising a bioactive ingredient. Said bioactive ingredient is part of a complex, further comprising a polyelectrolyte. The invention further relates to methods for producing a composition of the invention and to methods of preventing, reducing and/or eliminating the presence of a phytopathogen on a plant or on one or more plant parts.

### 1. INTRODUCTION

Agricultural pest control includes biological control means such as crop rotation, companion planting, breeding of pest-resistant cultivars, and the use of living organisms such as dogs to catch rodents, the use of physical traps such as sticky flypapers, garden guns, and the application of chemical control means. Chemical control is based on substances that are toxic to the pests involved, while causing little or no toxic effects to the agricultural plants. Chemical control agents or pesticides include lime and wood ash, sulfur, bitumen, nicotine, heavy metals such as copper, lead and mercury, and neem oil.

Chemical control agents can be incredibly beneficial and have contributed to increased food production over the past century. However, when a pesticide is applied it may be carried into the environment by leaching into the soil or drifting through the air. In addition, pesticide exposure to human sometimes may cause adverse health effects ranging from simple irritation of the skin and eyes to more severe effects such as affecting the nervous system. A major challenge in agriculture, therefore, is to control plant pests while reducing the amounts of chemical control agents that are applied.

Formulation of a pesticide may be used to enhance performance of the pesticide and, thereby, reduce the amount that is to be applied to be effective against the agricultural pest. A formulation may, for example, increase stickiness, increase rainfastness, and/or provide longer duration by slow release of the active ingredient.

The published international application WO 2008/002623 describes the use of ion exchanging polymers to provide slow release of a charged pesticide. Similarly, WO 2008/024509 describes the encapsulation of a bioactive ingredient into a cationic latex, thereby providing sustained release of the bioactive ingredient. US 2013/0244880 describes biologically degradable, water insoluble matrices encapsulating pesticides. Disagregation of the matrices would provide slow and controlled release of the pesticide.

Several documents, e.g. CN 102302037 and CN 103039468, describe that chitosan oligosaccharide works synergistically with fungicides and increases crop resistance itself. Furthermore, chitosan has recently been reported to be useful as a rainfastness adjuvant (Symonds et al., 2016. RSC Adv 6, 102206). In addition, a low molecular weight chitosan obtained from biomass of Argentine Sea's crustaceans has been reported to have some activity against Phytophthora infestans and Fusarium solani f. sp. eumartii (Ippõlito et al., 2017. In: Biological Activities and Application of Marine Polysaccharides, Emad A. Shalaby (ed), IntechOpen).

Furthermore, WO 2013/133705 and WO 2013/133706 describe the use of a neutral, insoluble polyelectrolyte complex, generated by mixing a polycation and a polyanion under slightly acidic conditions. Said polyelectrolyte complex was found to improve the protective effect of a biocide that was adhered to the polyelectrolyte complex, in comparison with the same biocide without said polyelectrolyte complex.

It is an objective of the present invention to provide a composition that allows to further reduce the amounts of an agricultural bioactive ingredient to protect a plant against phytopathogenic pests. Said composition preferably increases stickiness, humectancy and rainfastness, and/or provides longer duration by slow release of the bioactive ingredient.

### 2. SUMMARY OF THE INVENTION

The present invention provides a composition, comprising a complex between a polycation and a bioactive ingredient. The polycation and a bioactive ingredient are preferably present in a relative amounts of between 1:1 and 1:20. such as between 1:1 and 1:5, having an average particle size of between 100 nanometer and 20 micrometer. Said bioactive ingredient preferably is a negatively charged bioactive ingredient, comprising a carboxylic acid group, a nitro group, or a phosphonate group.

Said bioactive ingredient preferably is a fungicide and/or a pesticide.

Said polycation preferably is selected from polyallylamine and chitosan.

Said bioactive ingredient preferably is selected from 2,4D, dicamba, pelargonic acid, imidacloprid, clothianidin, Fosetyl Al, glyphosate, natamycin, phosphonate salts.

A composition according to the invention may comprise an additional bioactive ingredient, preferably a fungicide and/or a herbicide.

A composition according to the invention may further comprise an agriculturally acceptable carrier.

The invention further provides a method for producing a composition according to the invention, comprising (a) providing an aqueous composition of a polycation, (b) quickly adding a bioactive ingredient to the aqueous composition of a polycation, while keeping the pH of the mixture below pH=5.5, preferably below 4.5, by addition of an acid, and mixing the composition; (c) optionally, crushing a formed insoluble complex and, optionally, (d) adding an additional bioactive ingredient biocide to at least one of the previous steps.

The invention further provides an use of a composition according to the invention for the protection of a plant, or a part of a plant, against a pathogen, preferably whereby the composition is sprayed over a plant or a part of a plant.

The invention further provides a method of protecting a plant, or a part of a plant, against a pathogen, comprising contacting said plant, or part of said plant, with a composition according to the invention.

The invention further provides a method of preventing, reducing and/or eliminating the presence of a pathogen on a plant, or a part of a plant, comprising contacting said plant, or part of said plant, with a composition according to the invention. Said part of a plant preferably is seed or fruit.

The invention further provides a method of controlling diseases caused by a phytopathogen, comprising contacting a plant, or a propagation material thereof, with a composition according to the invention.

The invention further provides a method for preventing development of soilborne pathogens in or on a soil comprising (a) providing a composition according to the invention and (b) adding the composition to the soil.

The invention further provides a method for preventing development of a pest or weed in or on a soil, comprising (a) providing a composition according to the invention; and (b) adding the composition to the soil.

### 3. LEGENDS TO THE FIGURES

FIG. 1. Illustrations of PEI:2,4-D complexes. (A-B) Complexes of PEI: 2,4-D according to the WO2008002623 using a 1:5 (PEI:2,4-D) ratio. (A) Top view, (B) side view. (C-D) Complexes of PEI: 2,4-D according to US20130045869A1 with a ratio 1:3 (PEI:2,4-D) (C); and a ratio 1:5 (PEI:2,4-D) (D). (E-F) Complexes of PEI:2,4-D according to the present method with ratios of 1:3 (PEI:2,4-D) (E) and 1:5 (PEI:2,4-D) (F).

### 4. DETAILED DESCRIPTION

### 4.1 Definitions

The term “polyelectrolyte”, as is used herein, refers to a molecule consisting of a plurality of charged groups that are linked to a common backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged molecules, respectively, under substantial neutral conditions, i.e. at pH 6-8.

The term “complex”, as is used herein, refers to a complex of a polyelectrolyte (a polycation) which is linked by strong, but reversible intermolecular, non-covalent interactions, preferably electrostatic interactions, to a bioactive ingredient. The term “electrostatic interactions” includes ionic interactions, hydrogen bonds, and van der Waals forces such as dipole-dipole interactions.

The term “free”, as is used herein, refers to a bioactive ingredient that is not part of a complex with a poly-ion. A free bioactive ingredient is a non-complexed form of said bioactive ingredient.

The term “negatively charged bioactive ingredient”, as is used herein, refers to a bioactive ingredient that has a net negative charge at about neutral pH (pH 6-8), has a delta negative charge at about neutral pH (pH 6-8), or that is neutral at about neutral pH but is ionizable.

The term “ionizable”, as is used herein, refers to a bioactive ingredient which comprises a functional group(s) that can be ionized or protonated in an aqueous solution. Examples of such ionizable bioactive ingredients include glufosinate and sulfonylurea. Said molecules are capable of dissociating into the corresponding cationic and anionic molecules, similar to salts such as copper sulfate.

The term “biological efficacy”, as is used herein, refers to the dose that is required for affecting organisms such as, for example, to control a disease. Efficacy may be expressed as the amount that is required to affect 50% of the maximal effective concentration. Biological efficacy is a measure of concentration and may be expressed in molar units, gram/L, w/w % or w/v %.

The term “rainfastness”, as is used herein, refers to the time after application of a bioactive ingredient that rainfall can impact the effectiveness of the bioactive ingredient. Rainfastness may be expressed in time, for example hours, or as an amount, such as a relative amount, of a bioactive ingredient that remains on a surface after application of a certain amount of water, such as 40 mm of water, optionally in a certain time period such as 40 mm of water in 30 minutes.

The term “humectancy”, as is used herein, refers to the retainment of moisture, preferably water. A higher humectancy of a complex between a polyelectrolyte and a bioactive ingredient results in the retainment of more water after a drying period. This may result in a more efficient rehydration on a plant or plant part with, for example, water from rain or dew and from moisture in the air, such that the bioactive ingredient makes contact with a surface such as a leaf and with insects on the surface. Humectancy makes the deposit stay moist, which improves the uptake of especially water-soluble bioactive ingredients.

The term “soil retention”, as is used herein, refers to the retention of a bioactive ingredient in a soil, for example through chemical interactions. Soil retention may be expressed, for example, over time, e.g. over hours or days, or as a percentage of the applied bioactive ingredient that is washed out of a soil under specific conditions and over a specified time period. Soil retention may play a role in determining the availability over time of a bioactive ingredient throughout the soil.

The term “peptone”, as is used herein, refers to a water-soluble mixture of polypeptides and amino acids formed by partial hydrolysis of protein, especially of yeast protein.

The term “phosphonate salt”, as is used herein, refers to a salt or ester of phosphorous acid (HPO(OH)₂). Upon mixing of phosphorous acid with water, a strong acid, phosphonic acid, is formed. This acid is often neutralized with an alkali salt such as potassium hydroxide to form mono-and di-potassium salts of phosphorous acid (often referred to as potassium phosphite). Other phosphonate salts include alkali metal salts, especially disodium hydrogen phosphite and sodium dihydrogen phosphite, diammonium hydrogen phosphite and ammonium dihydrogen phosphite, magnesium hydrogen phosphite, and calcium hydrogen phosphite, or mixtures thereof.

The term “chitosan”, as is used herein, refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” includes chitosan, oligochitosan, which is characterized by, for example, chemical treatment and/or radiation, chitosan derivatives and mixtures of chitosan and chitosan derivatives.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “soil”, as used herein, refers to the soil or soil substitute that pertains to and supports the growth and/or development of a plant or a tree or a fungus such as a mushroom. The term “soil” thus includes compost and compost tea.

The term “bioactive ingredient”, as is used herein, refers to a chemical substance capable of preventing growth, or killing living organisms. Bioactive ingredients are commonly used in medicine, agriculture, forestry, and in industry where they prevent the fouling of, for example, water, agricultural products including seed, and oil pipelines. A bioactive ingredient can be a pesticide, including a fungicide, herbicide, insecticide, algicide, molluscicide, miticide and rodenticide; and/or an antimicrobial compound such as a germicide, an antibiotic compound, an antibacterial compound, an antiviral compound, an antifungal compound, an antiprotozoal compound and/or an antiparasitic compound.

As used herein, the term “pest” includes, but is not limited to, insect, nematode, weed, fungi, algae, mite, tick, and animal. Said pest preferably is a phytopathogenic fungi, an unwanted insect, and/or a weed.

As used herein, the term “weed” refers to any unwanted vegetation.

As is used herein, the term “pesticide” includes, but is not limited to, a herbicide, insecticide, fungicide, nematocide, mollusks repellent and a control agent.

The terms “controlling a pest” and “pest control”, as used herein, refers to preventive, persistence, curative and/or knock down treatment of a pest.

The term “polyene fungicide”, as used herein, refers to a polyene macrolide antifungal that possess antifungal activity such as natamycin, lucensomycin, filipin, nystatin or amphotericin B, most preferred natamycin. Derivatives of a polyene fungicide, such as derivatives of natamycin, are also included. A preferred derivative is a salt or a solvate of a polyene fungicide and/or a modified form of a polyene fungicide such as e.g. different shaped crystal forms such as the needle-shaped crystal of natamycin described in U.S. Pat. No. 7,727,966.

The term “suspension concentrate”, as used herein, refers to a suspension of solid particles in a liquid intended for dilution with water prior to use.

The term “dispersion concentrate”, as used herein, refers to a dispersion of solid particles in a liquid intended for dilution with water prior to use.

The term “water dispersible granules”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder”, as used herein, refers to a powder formulation that is made into a slurry in water prior to use.

### 4.2 Bioactive Complexes

In a first aspect, the invention provides a composition comprising a complex of a polyelectrolyte and a bioactive ingredient, wherein said complex is characterized by intermolecular, non-covalent interactions, preferably electrostatic interactions such as ionic interactions, hydrogen bonds and van der Waals forces, such as dipole-dipole interactions, between said polyelectrolyte and said bioactive ingredient. Said bioactive ingredient and the polyelectrolyte preferably are present in a complex of the invention in a ratio between 20:1 and 1:1 (w/w), more preferred in a ratio between 10:1 and 1:1 (w/w), such as between 7:1 and 1:1 (w/w), including 5:1.

Said complex of a polyelectrolyte and a bioactive ingredient preferably has an average particle size (volume-based) D90 of less than 20 micrometer, meaning that 90% of the particles is below 20 micrometer. Said particle size preferably is between 100 nanometer and 20 micrometer, such as between 0.5 and 10 micrometer, including about 1 micrometer and about 3 micrometer.

A complex between a polyelectrolyte and a charged, or locally charged, bioactive ingredient is formed when a polycation solution is mixed with a neutral or charged negative, or delta-negative charged, bioactive ingredient, preferably in an aqueous solution. Said mixing preferably is performed under neutral or slightly acidic or alkaline conditions. The positively charged polyelectrolytes will interact electrostatically with the neutral or (delta) negative charged bioactive ingredient to form a complex.

The interaction of a positively charged polyelectrolyte with a (delta) negatively charged bioactive ingredient is taught to result in the encapsulation/complexation of the bioactive ingredient by the polyelectrolyte. A thus encapsulated and/or complexed bioactive ingredient shows enhanced biological efficacy, improved persistence, soil retention, and improved rainfastness and humectancy, when compared to a non-encapsulated and/or not complexed bioactive ingredient. A thus encapsulated and/or complexed bioactive ingredient also shows enhanced biological efficacy, improved persistence and improved rainfastness, when compared to the same bioactive ingredient that is added to an already formed polyelectrolyte complex, as described in WO 2013/133705 and WO 2013/133706.

A complex between a polyelectrolyte and a charged, or locally charged, bioactive ingredient is also formed when a polycation is mixed in solution with a neutral or negatively charged, or delta charged, bioactive ingredient, preferably in an aqueous solution. Said mixing preferably is performed under neutral or slightly acidic or alkaline conditions. The positively charged polycations interact electrostatically with the neutral or (delta) negatively charged bioactive ingredient to form a complex. The electrostatic attraction between the protonated amino groups of the polycation and the negative charges of the active ingredient is the main driving force in the formation of such complexes.

A preferred bioactive ingredient is selected from a fungicide, herbicide and/or insecticide.

An insecticide preferably is selected from a nicotinic agonistic guanidine derivative such as clothianidin (1-[(2-chloro-1,3-thiazol-5-yl)methyl]-3-methyl-2-nitroguanidine), imidacloprid ((NE)-N-[1-[(6-chloropyridin-3-yl)methyl]imidazolidin-2-ylidene]nitramide), thiamethoxam ((NZ)-N-[3-[(2-chloro-1,3-thiazol-5-yl)methyl]-5-methyl-1,3,5-oxadiazinan-4-ylidene]nitramide), and dinotefuran (2-methyl-1-nitro-3-[(tetrahydro-3-furanyl) methyl] guanidine).

A herbicide preferably is selected from a methoxybenzoic acid such as dicamba (3,6-dichloro-2-methoxybenzoic acid), the phenoxy carboxylic acid family of herbicides such as 2,4D (2-(2,4-dichlorophenoxy)acetic acid) and salts thereof such as 2,4D choline, a carboxylic acid chloride such as pelargonic acid (nonanoic acid) and esters and salts thereof, glyphosate (N-(phosphonomethyl)glycine), phosphoramidothioic acid (0,0-diethyl N-1,3-dithiolan-2-ylidenephosphoramidothioate), phosphorodithioic acid (trihydroxy(sulfanylidene)-λ5-phosphane), carbamoylphosphonic acid (fosamine; carbamoyl(ethoxy)phosphinic acid), dinitrophenol (2,4-dinitrophenol), amiprophos-methyl (N-[methoxy-(4-methyl-2-nitrophenoxy)phosphinothioyl]propan-2-amine), butamiphos (N-[ethoxy-(5-methyl-2-nitrophenoxy)phosphinothioyl]butan-2-amine), dithiopyr (3-S,5-S-dimethyl 2-(difluoromethyl)-4-(2-methylpropyl)-6-(trifluoromethyl)pyridine-3,5-dicarbothioate), thiazopyr (methyl 2-(difluoromethyl)-5-(4,5-dihydro-1,3-thiazol-2-yl)-4-(2-methylpropyl)-6-(trifluoromethyl)pyridine-3-carboxylate), hydroxyphenoxyisopropionamide-derivatives such as chlorazifop (2-[4-(3,5-dichloropyridin-2-yl)oxyphenoxy]propanoic acid), clofop (2-[4-(4-chlorophenoxy)phenoxy]propanoic acid) and fenthiaprop (2-[4-[(6-chloro-1,3-benzothiazol-2-yl)oxy]phenoxy]propanoic acid), dinitroaniline (3,4-dinitroaniline), chloro-carbonic-acid-derivatives such as dalapon (2,2-dichloropropanoic acid) and flupropanate (2,2,3,3-tetrafluoropropanoic acid), pyridine carboxylic acids such as aminopyralid (4-amino-3,6-dichloropyridine-2-carboxylic acid), clopyralid (3,6-dichloropyridine-2-carboxylic acid) and triclopyr ([(3,5,6-trichloro-2-pyridinyl)oxy]acetic acid), quinoline carboxylic acid derivatives such as quinmerac (7-chloro-3-methylquinoline-8-carboxylic acid), phthalamate (2-carbamoylbenzoate), and quinclorac (3,7-dichloroquinoline-8-carboxylic acid), hydroxyphenoxyisopropionic acid derivatives such as clodinafop-propargyl (prop-2-ynyl (2R)-2-[4-(5-chloro-3-fluoropyridin-2-yl)oxyphenoxy]propanoate), fenoxaprop-P ((2R)-2-[4-[(6-chloro-1,3-benzoxazol-2-yl)oxy]phenoxy]propanoic acid) and quizalofop (2-[4-(6-chloroquinoxalin-2-yl)oxyphenoxy]propanoic acid), amide derivatives such as chlorthiamid (2,6-dichlorobenzenecarbothioamide), phenylcarbamate, benzamide, and chloroacetamide (2-chloroacetamide), carboxamide derivatives such as triazolocarboxamide (1H-1,2,4-triazole-5-carboxamide), amicarbazone (4-amino-3-isopropyl-N-(2-methyl-2-propanyl)-5-oxo-4,5-dihydro-1H-1,2,4-triazole-1-carboxamide) and flupoxam (1-[4-chloro-3-(2,2,3,3,3-pentafluoropropoxymethyl)phenyl]-5-phenyl-1,2,4-triazole-3-carboxamide), methylurea derivatives such as cinosulfuron (1-(4,6-dimethoxy-1,3,5-triazin-2-yl)-3-[2-(2-methoxyethoxy)phenyl]sulfonylurea), imazosulfuron (1-(2-chloroimidazo[1,2-a]pyridin-3-yl)sulfonyl-3-(4,6-dimethoxypyrimidin-2-yl)urea), and metazosulfuron (1-[5-chloro-2-methyl-4-(5-methyl-5,6-dihydro-1,4,2-dioxazin-3-yl)pyrazol-3-yl]sulfonyl-3-(4,6-dimethoxypyrimidin-2-yl)urea), urea-derivatives such as methylurea (1-methylurea), benzthiazuron (1-(1,3-benzothiazol-2-yl)-3-methylurea), isouron (3-(5-tert-butyl-1,2-oxazol-3-yl)-1,1-dimethylurea), monisouron (1-(5-tert-butylisoxazol-3-yl)-3-methylurea), dimefuron (3-[4-(5-tert-butyl-2-oxo-1,3,4-oxadiazol-3-yl)-3-chlorophenyl]-1,1-dimethylurea) and methiuron (1,1-dimethyl-3-m-tolyl-2-thiourea), sulfonamide derivatives such as metosulam (N-(2,6-dichloro-3-methylphenyl)-5,7-dimethoxy-[1,2,4]triazolo[1,5-a]pyrimidine-2-sulfonamide), cloransulam (3-chloro-2-[(5-ethoxy-7-fluoro-[1,2,4]triazolo[1,5-c]pyrimidin-2-yl)sulfonylamino]benzoic acid), diclosulam (N-(2,6-dichlorophenyl)-5-ethoxy-7-fluoro-[1,2,4]triazolo[1,5-c]pyrimidine-2-sulfonamide), and pyroxsulam (N-(5,7-dimethoxy-[1,2,4]triazolo[1,5-a]pyrimidin-2-yl)-2-methoxy-4-(trifluoromethyl)pyridine-3-sulfonamide), diamine derivatives such as indaziflam (2-N-[(1R,2S)-2,6-dimethyl-2,3-dihydro-1H-inden-1-yl]-6-(1-fluoroethyl)-1,3,5-triazine-2,4-diamine), triaziflam (2-N-[1-(3,5-dimethylphenoxy)propan-2-yl]-6-(2-fluoropropan-2-yl)-1,3,5-triazine-2,4-diamine), iprymidam (6-chloro-4-N-propan-2-ylpyrimidine-2,4-diamine), tioclorim (6-chloro-5-(methylthio)pyrimidine-2,4-diamine), atraton (4-N-ethyl-6-methoxy-2-N-propan-2-yl-1,3,5-triazine-2,4-diamine), chlorazine (6-chloro-2-N,2-N,4-N,4-N-tetraethyl-1,3,5-triazine-2,4-diamine), and simeton (2-N,4-N-diethyl-6-methoxy-1,3,5-triazine-2,4-diamine), aminotriazinedione derivatives such as ametridione (1-amino-3-(2,2-dimethylpropyl)-6-(ethylsulfanyl)-1,3,5-triazine-2,4(1H,3H)-dione), aminotriazinone derivatives such as ethiozin (4-amino-6-tert-butyl-3-(ethylthio)-1,2,4-triazin-5(4H)-one) and isomethiozin (6-tert-butyl-4-[(1EZ)-2-methylpropylidene]-3-(methylthio)-1,2,4-triazin-5(4H)-one), pyridazone derivatives such as brompyrazon (5-amino-4-bromo-2-phenylpyridazin-3(2H)-one), and metflurazon (4-chloro-5-(dimethylamino)-2-[3-(trifluoromethyl)phenyl]pyridazin-3(2H)-one), flufenpyr (2-[2-chloro-4-fluoro-5-[5-methyl-6-oxo-4-(trifluoromethyl)pyridazin-1-yl]phenoxy]acetic acid), aniline derivatives such as aclonifen (2-chloro-6-nitro-3-phenoxyaniline), chlornidine N,N-bis(2-chloroethyl)-4-methyl-2,6-dinitroaniline), fluchloralin (N-(2-chloroethyl)-2,6-dinitro-N-propyl-4-(trifluoromethyl)aniline), prodiamine (2,6-dinitro-N,N-dipropyl-4-(trifluoromethyl)-1,3-benzene diamine), and trifluralin (2,6-dinitro-N,N-dipropyl-4-(trifluoromethyl)aniline.

A fungicide preferably is selected from a polyene fungicide such as natamycin, a guanidine-containing compound such as a phosphonate salt, a salt of ethyl phosphonate anions and aluminum cations in a 3:1 ratio such as Fosetyl Al, fluazinam (3-chloro-N-[3-chloro-2,6-dinitro-4-(trifluoromethyl)phenyl]-5-(trifluoromethyl)-2-pyridinamine), binapacryl (2-(butan-2-yl)-4,6-dinitrophenyl 3-methylbut-2-enoate), meptyldinocap ((2,4-dinitro-6-octane-2-ylphenyl) (E)-but-2-enoate), dinocap (2,6-dinitro-4-octylphenyl crotonates and 2,4-dinitro-6-octylphenyl crotonates in which “octyl” is a mixture of 1-methylheptyl, 1-ethylhexyl and 1-propylpentyl groups), quintozene (1,2,3,4,5-pentachloro-6-nitrobenzene), dicloran (2,6-dichloro-4-nitroaniline), tecnazene (1,2,4,5-tetrachloro-3-nitrobenzene), flusulfamide (4-chloro-N-(2-chloro-4-nitrophenyl)-3-(trifluoromethyl) benzenesulfonamide), kasugamycin (2-amino-2-[(2R,3S,5S,6R)-5-amino-2-methyl-6-[(2R,3S,5S,6S)-2,3,4,5,6-pentahydroxycyclohexyl]oxyoxan-3-yl]iminoacetic acid), polyene macrolides such as natamycin ((1R,3S,5R,7R,8E,12R,14E,16E,18E,20E,22R,24S,25R,26S)-22-[(2R,3S,4S,5S,6R)-4-amino-3,5-dihydroxy-6-methyloxan-2-yl]oxy-1,3,26-trihydroxy-12-methyl-10-oxo-6,11,28-trioxatricyclo[22.3.1.05,7]octacosa-8,14,16,18,20-pentaene-25-carboxylic acid), polyoxin D (1-[(2R,3R,4S,5R)-5-[(S)-[[(2S,3S,4S)-2-amino-5-carbamoyloxy-3,4-dihydroxypentanoyl]amino]-carboxymethyl]-3,4-dihydroxyoxolan-2-yl]-2,4-dioxopyrimidine-5-carboxylic acid), streptomycin (2-[(1R,2R,3S,4R,5R,6S)-3-(diaminomethylideneamino)-4-[(2R,3R,4R,5S)-3-[(2S,3S,4S,5R,6S)-4,5-dihydroxy-6-(hydroxymethyl)-3-(methylamino)oxan-2-yl]oxy-4-formyl-4-hydroxy-5-methyloxolan-2-yl]oxy-2,5,6-trihydroxycyclohexyl]guanidine), oxytetracycline ((4S,4aR,5S,5aR,6S,12aR)-4-(dimethylamino)-1,5,6,10,11,12a-hexahydroxy-6-methyl-3,12-dioxo-4,4a,5,5a-tetrahydrotetracene-2-carboxamidefungicide), captan (2-[(trichloromethyl)sulfanyl]-3a,4,7,7a-tetrahydro-1H-isoindole-1,3(2H)-dione), and captafol (2-(1,1,2,2-tetrachloroethylsulfanyl)-3a,4,7,7a-tetrahydroisoindole-1,3-dione).

Said bioactive ingredient preferably is selected from 2,4D, dicamba, pelargonic acid, imidacloprid, clothianidin, Fosetyl Al, glyphosate, natamycin, and phosphonate salts.

A polycation, preferably a non-bioactive polycation, preferably is or comprises cationic starch, poly(allylamine), chitosan, chitosan oligosaccharide, epsilon-p-L-lysine, DEAE-dextran, or mixtures thereof, to form a complex with a bioactive anion. Said polycation is preferably selected from the group consisting of cationic starch, poly(allylamine) and chitosan, more preferably is poly(allylamine).

Preferred bioactive complexes according to the invention comprising a bioactive ingredient and a polycation are formed by chitosan and 2,4D, poly(allylamine) and 2,4D, chitosan and dicamba, poly(allylamine) and dicamba, chitosan and pelargonic acid, poly(allylamine) and pelargonic acid, chitosan and Fosetyl Al, poly(allylamine) and Fosetyl Al, chitosan and glyphosate, poly(allylamine) and glyphosate, chitosan and natamycin, poly(allylamine) and natamycin, chitosan and a phosphonate salt, and poly(allylamine) and a phosphonate salt.

A composition according to the invention may comprise an additional bioactive ingredient such as a fungicide, a herbicide, an insecticide, an acaricide, a molluscicide, a miticide, a rodenticide; and/or an bactericide. The term “additional”, as is used herein, refers to the presence of one of more further bioactive ingredients that differ from the bioactive ingredient that is present in the complex.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is a fungicide and/or a herbicide.

A preferred additional fungicide is a postharvest fungicide selected from sodium ortho-phenylphenate, 2-phenylphenol, 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(8-allyloxy-2,4-dichlorophenethyl)imidazole (imazalil; Janssen Pharmaceutica NV, Belgium) and N-propyl-N-[2-(2,4,6-trichlorophenoxy)ethyl] imidazole-1-carboxamide (prochloraz); a copper salt such as Bordeaux mixture (CuSO₄·3Cu(OH)₂·3CaSO₄), copper hydroxide, copper naphthenate, copper oxychloride ((CuCl₂·3Cu(OH)₂), tribasic copper sulphate (CuSO₄)₃Cu(OH)₂), cufraneb, cuprous oxide, mancopper and oxine-copper; cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; flurprimidol; flusulfamide; flutolanil; folpet (N-(trichloromethylthio)phthalimide); fosetyl-Al; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-alph-a-(methoxymethylene)benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phthalide; picobenzamid; picoxystrobin; piperalin; polyoxins; polyoxorim; procymidone; propamocarb; prop anosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)-N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide, and/or mixtures thereof.

A composition of the invention may also comprise two or more additional fungicides, such as, for example, natamycin and a strobilurin type of fungicides such as azoxystrobin, natamycin and a triazole type of fungicides such as cyproconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, natamycin and a phenylamide type of fungicide suich as metalaxyl, natamycin and a fungicide not belonging to a specific group of fungicides such as fludioxynil and/or folpet.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol [1,5A]pyrimidine; a photosynthetic inhibitor that binds D-1:quinone-binding protein, including anilides, benzimidazoles, biscarbamates, pyridazinones, triazinediones, triazines, triazinones, uracils, substituted ureas, quinones, hydroxybenzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from benzobicyclon, mesotrione, sulcotrione, tefuryltrione, tembotrione, 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxyethoxy)-4-(methylsulfonyl)phenyl](1-ethyl-5-hydroxy-1H-pyrazol-4-yl)-methanone, (2,3-dihydro-3,3,4-trimethyl-1,1-dioxidobenzo[b]thien-5-yl)(5-hydroxy-1-methyl-1H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

A composition according to the invention may further comprise one or more agriculturally acceptable carriers. Said agriculturally acceptable carrier preferably includes a stabilizer, a wetting agent, a dispersant, an antifreezing agent, an antifoaming agent and/or a thickening agent. The addition of small amounts of one or more agriculturally acceptable carriers may increase stability, efficacy and/or rainfastness of a composition according to the invention.

A stabilizer, when present, is preferably selected from carboxylic acids such as citric acid, acetic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to 5% (w/v), more preferred between 0.02 to up to 1% (w/v), more preferred about 0.05% (w/v).

A wetting agent, when present, is preferably selected from di-octylsuccinate, polyoxyethylene/polypropylene and tri-stearyl sulphonate/phosphate. A composition of the invention may also comprise two or more different wetting agents. A wetting agent is preferably present in an amount of between 0 to up to 20% (w/v), more preferred between 0.01 to up to 5% (w/v), more preferred between 0.02 to up to 1% (w/v), more preferred about 0.05% (w/v).

A dispersant, when present, is preferably selected from Morwet® D425, lignin sulphonate, an alkylpolysaccharide, an styrene acrylic polymer, an acrylic co-polymer, and ethoxylated tristyrenephenol phosphate, for example polyethoxylated fosforic acid. A composition of the invention may also comprise two or more different dispersants. A dispersant is preferably present in an amount of between 0 to up to 10% (w/v), more preferred between 0.01 to up to 5% (w/v), more preferred between 0.02 to up to 1% (w/v), more preferred about 0.05% (w/v).

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 25% (w/v), more preferred between 0.1 to up to 20% (w/v), more preferred between 0.2 to up to 10% (w/v).

An anti-foam forming agent, when present, is preferably selected from polymethylsiloxane, polydimethylsiloxane, simethicone octanol, and silicone oils. A composition of the invention may also comprise two or more different anti-foam forming agents. An anti-foam forming agent is preferably present in an amount of between 0 to up to 10% (w/v), more preferred between 0.05 to up to 5% (w/v), more preferred between 0.1 to up to 1% (w/v), more preferred about 0.05% (w/v).

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

A composition according to the invention preferably is in the form of a suspension concentrate (SC), a water dispersible granule (WG), a wettable powder (WP), a dispersion concentrate (DC), a dry powder seed treatment (DS), a water slurriable powder (WS), a flowable seed treatment (FS) or a water dispersible granule seed treatment (WG). Preferably, a composition of the invention is in the form of a suspension concentrate, or in the form of water dispersible granules. A most preferred composition is a suspension concentrate.

A composition according to the invention provides a stable aqueous suspension comprising a high concentration of a bioactive ingredient such as 2,4D, dicamba, pelargonic acid, imidacloprid, clothianidin, Fosetyl Al, glyphosate, natamycin, and phosphonate salts, up to about 50% (w/w), with improved biocidal activity compared to commercially available formulations of said bioactive ingredient, in the presence of relatively low amounts of adjuvants as agriculturally acceptable carriers.

A composition according to the invention further has improved physical properties, different morphology and particle size, as demonstrated for example by electron microscopy, when compared to a free bioactive ingredient such as 2,4D, dicamba, pelargonic acid, imidacloprid, clothianidin, Fosetyl Al, glyphosate, natamycin, and phosphonate salts.

The invention further provides a method for producing a composition according to the invention, comprising (a) providing an aqueous solution of a polycation, (b) mixing a negatively charged bioactive ingredient with a carboxylic acid (COOH⁻) group, a nitro (NOO⁻) group, a phosphonate (PO3⁻) group, or a combination thereof into the aqueous composition, while keeping the pH of the mixture between pH=3-9, preferably between 4-7, by addition of a base or an acid, (c) thereby producing a comprising a complex of a polyelectrolyte and a bioactive ingredient.

For this, an aqueous solution of a polycation is preferably prepared by solubilizing the polycation in an aqueous acidic solution comprising an acid such as, for example, lactate, hydrochloric acid, phosphorous acid, acetic acid and/or ascorbic acid. The amount of acid that is required to solubilize the polycation depends on the polycation, as is known to a skilled person. For example, for solubilizing chitosan, in general, about 6 ml 37% HCl is required to obtain a solution of 10 gram chitosan in 1 liter in water. As an alternative, a polycation is dissolved in an aqueous solution, preferably water, for example by gently shaking at 20-23° C. overnight, whereby a salt such as sodium chloride is preferably added to the aqueous solution at a concentration between 1 mM and 1 M, preferably about 100 mM.

Said active ingredient may be dissolved in an aqueous solution such as water on a magnetic stirrer. A non-soluble active ingredient may be suspended in water and milled, for example by adding glass beads (1 mm) in a stainless steel metal beaker until they reach a volume-based average particle size below 20 μm (90% of particles below 20 μm), as determined, for example, by laser diffraction. If needed, the suspension may be filtered with a sieve to remove the glass beads.

Said solid or dissolved active ingredient is quickly added to the polycation, without slow feeding of the active ingredient and, preferably, within 1 hour, more preferably within 30 minutes, meaning that the negatively charged bioactive ingredient is added within 60 minutes, more preferably within 30 minutes such as within 20 minutes, to the aqueous composition comprising the polycation. A person skilled in the art will appreciate that this time limit of adding an active ingredient within one hour for is applicable for volumes up to about 100 liters. Larger volumes may require a longer time period for adding the active ingredient. For example, to add 6000 liter of a solution comprising an active ingredient into a 20.000 liter vessel comprising the polycation, will take about 5 hours when added at a speed of 20 liter/minute. As this addition normally would take at least one day, the term “quickly adding” covers a time limit of up to 12 hours for large volumes of more than about 100 liters of an active ingredient, more preferably up to 10 hours, more preferably up to 6 hours.

During and preferably also after the addition of the active ingredient the composition is mixed. During mixing, the temperature is preferably kept between 0° C. and 100° C., more preferred between 10° C. and 60° C., more preferred kept at ambient temperature (15-25° C.). The resulting mixture is preferably stirred during formation of the complex. Following formation of the complex, a dispersant and/or a wetting agent is preferably added.

By quickly adding the active ingredient to the polycation, preferably within 60 minutes, a complex is formed between the polycation and the negatively charged bioactive ingredient, with an average particle size (volume based) of between 100 nanometer and 20 micrometer.

The relative amounts of a polycation and a bioactive ingredient that are combined in step b) of a method according to the invention is between 1:1 and 1:20 (w/w), more preferred in a ratio between 1:1 and 1:10, including 1:2, and 1:5 (w/w). The final pH value of the resulting composition may be adjusted to a pH value of between 3-12, more preferred between 4-9, most preferred between 5-8.

### 4.3 Methods of Use

A composition according to the invention is suitable for the control of pests that are encountered in horticulture, agriculture, and forestry. The compositions are active against normally sensitive and resistant pest species and during all or individual stages of development. Prior to use, a composition according to the invention is preferably dissolved or dispersed in water, or diluted with water, to provide an aqueous composition comprising between 0,001 and 5 w/v % of the bioactive ingredient. If required, an agriculturally acceptable carrier such as a sticking agent is added to the diluted aqueous composition.

A composition according to the invention is preferably diluted 2-1000 times, preferably about 200 times, with an aqueous solvent, preferably water, to contain between 0.0001 and 1% (w/v) of the bioactive ingredient, prior to contacting a plant, plant part, or soil with the composition.

To control agricultural pests, the invention provides a use of a composition according to the invention for the protection of a plant, or a part of a plant, against a pathogen. In order to achieve this effect, said plant or plant part is contacted with said composition, including a diluted aqueous composition. Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating {e.g. by means of wax or electrostatically). In addition, the composition, including a diluted aqueous composition, may be injected into the soil.

For example, a plant of part thereof may be coated with a diluted aqueous composition comprising an bioactive ingredient according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention further provides a method of controlling diseases caused by phytopathogenic fungi in plants or on propagation material thereof, which method comprises contacting the plants, or propagation material thereof, with a composition according to the invention, including an aqueous diluted composition.

The invention further provides a method for preventing development of soilborne pathogens in/on a soil comprising (a) providing a composition according to the invention; (b) adding the composition to the soil. A composition according to the invention may be used for treating any soil used for growing crops in agriculture, horticulture or mushroom cultivation against soilborne pathogens.

The invention further provides a method for preventing development of soilborne pathogens in or on a soil, comprising (a) providing a composition according to the invention; (b) adding the composition to the soil.

The invention further provides a method of preventing, reducing and/or eliminating fungi, bacteria and/or viruses in or on a soil, comprising (a) providing a composition according to the invention; (b) adding the composition to the soil.

A composition according to the invention can be added directly to the soil, according to any method known in the art e.g. by spraying it on the soil, mixing it through the soil, or by dipping the soil. In addition, a composition of the invention may also be added to an ingredient of or to any composition that is applied to the soil, e.g. such as fertilizers, nutrient compositions and agents against other unwanted organisms such as insects, nematodes and/or mites. Said soil can be used for the production of any agricultural or horticultural product herein to be understood in a very broad sense and including, but not limited to, edible crops such as cereals, vegetables, fruit, nuts/beans/seeds, herbs/spices and mushrooms; industrial crops; crops grown for feed; ornamental crops such as plants, flowers, bushes and trees.

A composition of the invention may be applied at any suitable moment which of course will differ per crop and growth conditions such as the climate. It can e.g. be added to the soil before seeding or planting; before, during and/or after the growth of the crop; and at different seasons such as before during and after the spring, summer, autumn and/or winter.

In case of mushroom cultivation a composition of the invention can be mixed through the growth substrate (e.g. compost) or sprayed on the growth substrate and/or top-layer (e.g. the casing) at any stage of the production process of the growth substrate and/or at any stage of the mushroom growth cycle such as: before during or after fermentation of the compost; after spawning; after casing; together with one or more of the watering steps; before, during and after pinning; after harvesting the first and/or second harvest; or any combination of the above mentioned stages. A composition of the invention can also be added to the spawn, the gypsum, the nutrient supplements and other additives usually applied in mushroom cultivation, or to any substance which is part of the mushroom growth substrate.

### EXAMPLES

### Example 1

Materials and Methods

To determine interaction between polyelectrolytes (PE; Table 1) and active ingredients (AI; Table 2) aqueous stock solutions of about 200 g/L of the PE and of the active ingredients were prepared. The polyelectrolytes were diluted in water and stirred on magnetic stirrer for at least 30 minutes until a homogenous clear solution was obtained (ratios and amounts are presented in Table 4). The active ingredients were dissolved in water on magnetic stirrer or, if they weren't water soluble, suspended in water and milled by adding glass beads (1 mm) in a stainless steel metal beaker until they reach a volume-based average particle size below 20 μm (90% of particles below 20 μm), as determined by laser diffraction. After that the mixture was filtered with a sieve to remove glass beads and the filtrate was used for further analysis.

TABLE 1
Polyelectrolytes tested.

| Product | Product name | Supplier | Batch |
|---|---|---|---|
| Polyallylamine*HCl | Allylamine | Cheghui- | 18060701 |
| 50% | hydrochloride | Shuangda | |
| | polymer | | |
| Chitosan | Bovlin Chitosan | Shaanxi Bolin | BL2018050 |
| | Hydrochloride | Biotechnology | 5CHP |
| Sodium lignosulfonate | Borresperse NA | Borregaard | 6/90200 |

TABLE 2
Active ingredients tested.

| Chemical group | Active ingredient |
|---|---|
| Molecule with carboxylic acid (COOH⁻) | 2,4D |
| group | Dicamba |
| | Natamycin |
| | Pelargonic acid |
| | Peptone (COO⁻ group) |
| | Proline (COO⁻ group) |
| Molecules with nitro (NOO—) group | Clothianidin |
| | Thiamethoxam |
| | Imidacloprid |
| Molecules with phosphonate (PO3⁻) | Fosetyl Al |
| group | Glufosinate |
| | Glyphosate |
| | ((NH4)2HPO3) |
| | (K2HPO3) |
| | (Na2HPO3) |

A polyelectrolyte solution, PAA or chitosan, was added to a 100-150 mL glass beaker, followed by water and an active ingredient solution/suspension. The mixture was stirred for at least 4 hours, and samples were observed after at least 16 hours. The visual observable interactions were divided into five categories (see Table 3). The categories were chosen by comparison to a blank sample containing the same concentration of active ingredient in water but without polyelectrolyte. The order of adding the polyelectrolyte, water and active ingredient did not change whether or not a complex was formed, but sometimes resulted in a different observation category. Interactions were studied over a large range of active ingredient to polyelectrolyte ratios, including 10.000:1 (w/w), 1000:1 (w/w), 100:1 (w/w), 10:1 (w/w), 1:1 (w/w), 1:10 (w/w), 1:100 (w/w) and 1:1000) (w/w).

TABLE 3
Categories of visual observations upon polyelectrolyte
- active ingredient interaction.

| Observation | Category |
|---|---|
| Formation of a precipitate | P |
| Formation of a gel | G |
| Formation of a coacervate | C |
| Increase/decrease of the sediment volume | V |
| Decrease of solid by increase of solved active ingredient | S |
| No visual observable interaction | N |

Results

Results are provided in Table 4. At high active ingredient:polyelectrolyte ratios (w/w), no visible interactions were observed, probably because the amount of polyelectrolyte was too low for an interaction to occur. A high polyelectrolyte:active ingredient ratio (w/w) a visual interaction could not be scored as the active ingredient may be complexed to the polyelectrolyte but the large number of free charges on the polyelectrolyte keep the active ingredient-polyelectrolyte complex in solution.

TABLE 4

| Name active | Active ingredient: PAA | | | | | | | | | | | |
|---|---|---|---|---|---|---|---|---|---|---|---|---|
| ingredient/ratio | “100.000:1” | “10.000:1” | “1.000:1” | “100:1” | “10:1” | “5:1” | “2:1” | “1:1” | “1:10” | “1:100” | “1:1000” | “1:10.000” |

Containing carboxylic acid (COOH—) group

| | | | | | | | | | | | |
|---|---|---|---|---|---|---|---|---|---|---|---|
| 2,4D | | N | G | G | G | G | G | G/P | P | P | N |
| Dicamba | N | P | P | P | G | G | G | G | N | N | |
| Natamycin | | | N | V | V | V | V | V | N | N | |
| Pelargonic acid | | N | G | G | P | P | P | P | P | N | N |
| Peptone | | N | P | P | P | ND | ND | N | N | N | N |
| Proline | | N | N | N | N | ND | ND | N | N | N | N |

Containing nitro (NOO—) group

| | | | | | | | | | | |
|---|---|---|---|---|---|---|---|---|---|---|
| Imidacloprid | N | V | V | V | No | N | N | N | N | |
| Clothianidin | N | V | V | P | P | P | P | N | N | N |

Containing phosphonate (RHPO3—) group

| | | | | | | | | | | |
|---|---|---|---|---|---|---|---|---|---|---|
| (NH4)2HPO3 | N | N | N | C | C | C | C | N | N | |
| K2HPO3 | N | N | N | C | C | C | C | N | N | |
| Na2HPO3 | N | N | N | C | C | C | C | N | N | |
| Fosetyl Al | V | V | V | V | ND | ND | P | N | N | N |
| Glyphosate | N | N | G | G | G | G | N | N | N | N |

Active ingredient: chitosan

| | | | | | | | | | |
|---|---|---|---|---|---|---|---|---|---|
| Dicamba | N | P | P | P | P | N | N | N | N |
| 2,4-D | N | N | P | P | P | P | P | N | N |

From these data it can be concluded that the polycation PAA interacts over a large range of ratio's with 2,4D, dicamba, natamycin, pelargonic acid, peptone, imidacloprid, clothianidin, NH4)2HPO3, K2HPO3, Na2HPO3, Fosetyl Al, glyphosate, and folpet. This interaction can be in the form of a gel, a precipitate, a coacervate and/or an increase in precipitated volume. Dicamba, 2,4D, natamycin were also found to interact with chitosan. Proline did not interact with PAA. The carboxylic acid (COOH⁻) group-containing active ingredients and the nitro (NOO⁻) group-containing active ingredients interacted at ratios between 1000:1 and 1:1 (w/w; active ingredient:polycation), while dicamba also interacted at 10.000:1 (w/w; active ingredient:polycation) with PAA but not with chitosan. Imidacloprid did not show a visible interaction with PAA at 5:1, 2:1 and 1:1 (w/w; active ingredient:polycation) with PAA.

The phosphonate (RHPO3−) group-containing active ingredients and the ammonium (N+) group)-containing active ingredients interacted at ratios between 10:1 and 1:1 (w/w; active ingredient:polycation), while Fosetyl Al interacted over a large range, from 10.000:1 to 1:1 (w/w; active ingredient:polycation) with PAA. The active ingredients 2,4D, dicamba, pelargonic acid, NH4)2HPO3, K2HPO3, Na2HPO3, and glyphosate, were also tested for interacting with the polyanion sodium lignosulfonate, but did not form a visible complex.

### Example 2. Humectancy of Complexes

Materials and Methods

The complexes of the interaction assay were used to conduct a humectancy assay. For this, 1 ml samples of active ingredient:polyelectrolyte complexes (see examples below), 1 sample outside the interaction ratio, and 1 sample without polyelectrolyte were placed in quadruple in tiered polystyrene weighing trays of 45×45 mm, with a height of 10 mm. After reweighing on an analytical balance, the trays were placed in a climate chamber and stored for at least 2 days at 54° C. or until no further weight change was observed. Then the trays were stored in a closed airtight box with 97% relative humidity inside by using a saturated solution of dipotassium sulfate. The air tight box was 20 cm×12 cm×7 cm. In the box a chicken wire construct was used to create two levels with 10-20 ml of saturated solution of dipotassium sulfate in a petri dish in a lower level, and the samples in an upper level. Boxes were located into an incubator at 25° C. The boxes were incubated for at least 5 days at 25° C. before use to allow equilibration of temperature and humidity. Hereafter, the trays were reweighed.

The change in humectancy by combining a pesticide and polyelectrolyte is expressed as percent value by multiplying the sample weight after incubation (w2) with 100 divided with the sample weight before incubation (w1) using the following equation:

$$\% Humectancy = 100 * \frac{w 2}{w 1} . \qquad ( Equation 1 )$$

To evaluate the effect of the interaction of the active ingredient and polyelectrolyte on humectancy (synergetic/antagonistic/no effect), the determined Humectancy of the samples containing both active ingredient and polyelectrolyte “Humectancy (blend)” was divided by the theoretical value of Humectancy of the blend provided by respective proportion (% AI; % PE) of each pesticide and polyelectrolyte using the following equation:

$$Effect = \frac{Humectancy ( blend )}{Humectancy ( AI ) * \% AI + Humectancy ( PE ) * \% PE} . \qquad ( Equation 2 )$$

Synergy was calculated using the Colby formula (Colby, 1967. Weeds 15: 20-22). According to this formula, a positive result of more than 1 is indicative of synergy.

Results

The Humectancy results are shown in Table 5.

TABLE 5
Humectancy of complexes.

| | Active ingredient/ | | Visible | |
|---|---|---|---|---|
| | polyelectrolyte | Humectancy | interaction | Synergy* |
| 1 | Clothianidin | 120.0% | | |
| | PAA | 198.8% | | |
| | 10.000:1 | 108.4% | No | 0.90 |
| | 1:1 | 167 | Yes | 1.05 |
| | 0.1:1 | 238.1% | Yes | 1.24 |
| 2 | Fosetyl Al | 137.0% | | |
| | PAA | 198.8%. | | |
| | 100.000:1 | 134.0% | No | 0.9780 |
| | 1:1 | 195.9% | Yes | 1.1667 |
| | 1:10 | 251.1% | Yes | 1.2998 |
| 3 | Glyphosate | 231.3% | | |
| | PAA | 198.8% | | |
| | 1000:1 | 220.0% | No | 0.95 |
| | 10:1 | 244.0% | Yes | 1.07 |
| 4 | 2,4-D | 212.7% | | |
| | Chitosan | 252.8% | | |
| | 10.000:1 | 205.3% | No | 0.96 |
| | 5:1 | 226.0% | Yes | 1.03 |
| 5 | Imidacloprid | 108.4% | | |
| | PAA | 198.8%. | | |
| | 10.000:1 | 102.2% | No | 0.940 |
| | 1:1 | 190.6% | Yes | 1.2408 |

As is clear from Table 5, all samples in which a visible interaction was scored between the active ingredient and polyelectrolyte, were found to be synergistic in the Humectancy assays, while all samples in which no visible interaction could be observed, were not synergistic.

### Example 3. The Effect of PAA on the Efficacy of Natamycin Against Botrytis cinerea after Rain Simulation on Tomato Leaves

Materials and Methods

Tomato plants were sprayed with different natamycin:PAA combinations at different dose rates in a formulation as presented in Table 6. The natamycin:PAA combinations are presented in Table 7.

An antifreeze agent and a wetting agent were obtained from Carl-Roth GmbH, an emulsifier, a dispersant, and an anti-foaming agent were obtained from Croda GmbH, a microbiocide was obtained from Thor GmbH, a thickener was obtained from Solvay AG and Polyallylamine*HCl (PAA; 50% solution) was obtained from J&H Chemical.

TABLE 6
Composition of formulations of Natamycin:PAA as the indicated
w/w ratio's, and of natamycin control without PAA. “natamycin
crude” contains 60% w/w natamycin. All values are in gram.

| Composition | 1000:1 PAA | 10:1 PAA | NO PAA |
|---|---|---|---|
| Natamycin (crude) | 269.7 | 269.8 | 269.8 |
| PAA (50% solution) | 0.5 | 54.0 | 0.0 |
| Wetting agent | 10-50 | 10-50 | 10-50 |
| Anti-freezing agent | 50-250 | 50-250 | 50-250 |
| Dispersant | 8-30 | 8-30 | 8-30 |
| Antifoaming agent | 2-10 | 2-10 | 2-10 |
| Microbiocide | 0.1-0.3 | 0.1-0.3 | 0.1-0.3 |
| Thickener | 0.2-2 | 0.2-2 | 0.2-2 |
| Water | 507.5-779.5 | 453.9-725.9 | 507.9-779.9 |
| Total | 1120 | 1120 | 1120 |

TABLE 7
Natamycin:PAA combinations tested on efficacy against Botrytis
after different rain simulations. The levels of PAA can be calculated
from the natamycin:PAA ratio and natamycin dose rates.

| Natamycin:PAA | Visible interaction | Natamycin dose rates |
|---|---|---|
| ratio | Yes/No | tested (ppm) |
| 1:0 (no PAA) | — | 25, 75, 125 and 200 |
| 1000:1 | No | 25, 75, 125 and 200 |
| 10:1 | Yes | 25, 75, 125 and 200 |

After spraying the tomato plants with the different natamycin/PAA solutions in a greenhouse, they were left overnight in the dark. Next day they were subjected to 15 mm of rainfall and left for drying.

The rain application was as follows: The tomato plant received via a full cone nozzle (Full cone nozzle; spray angle: 60-degree, Type: 468.604, Manufacturer: Lechler) that was mounted 1 m above the plants a rain simulation for 5 minutes. The water pressure was 2 bar. At the end of the rain simulation the plants had received an amount of water that was similar to 15 mm of rain.

After the plants had dried, inoculation was done with a Botrytis spore concentration of 0.6*10⁶ spores/ml in half PDB agar (13.25 g of Potato Extract Glucose Broth; Carl Roth, in 1 L distilled water). Inoculation was done by spraying each leaf with 800 microliters of the spore suspension using a paint brush sprayer. Hereafter the inoculated leaves were placed in a petri dishes containing water agar (2% water agar (Agar-Agar, BioScience-Grade) was used. Water agar was supplemented with benzimidazole (30 mg/L) in order to inhibit leaf senescence. Likewise, the antibiotics penicillin and streptromycin (both 200 mg/L medium) was added in order to inhibit the growth of bacteria and other fungal infection in the agar medium. 20 ml of 2% water agar described as above was poured in each square Petri dish (120×120×17 mm; Greiner Bio-One International). The antibiotics in the agar medium had no adverse effect on Botrytis development on tomato leaves.

Two leaves were incubated per Petri dish and the experiment was performed in triplicate. Incubation was in the dark at 25° C. The efficacy results are presented in Table 8.

TABLE 8
Effect of complex formation on natamycin efficacy against Botrytis
on tomato leaves after rain simulation. The data were measured 4 days
past inoculation. Presented is the efficacy percentage compared to
a water control without natamycin/PAA). Letters indicate significant
difference among the treatments (P < 0.05) within each group.

| | Efficacy (%) | | |
|---|---|---|---|
| Natamycin:PAA | Dose rate natamycin (ppm) | | |
| ratio | 25 | 75 | 200 |
| 1:0 (no PAA) | 2.8 ± 1.8 a | 9.7 ± 2.6 a | 30.6 ± 4.6 b |
| 1000:1 (no vis. inter.) | 2.8 ± 1.8 a | 13.9 ± 6.0 a | 13.9 ± 2.8 a |
| 10:1 (vis. interaction) | 15.3 ± 2.6 b | 31.9 ± 7.3 b | 34.7 ± 6.2 d |

The effect of natamycin+PAA was also studied at 4 different concentrations. This experimental setup is as the previous experiment but the disease was measured 3 days past inoculation with Botrytis. The results are presented in Table 9.

TABLE 9
Effect of PAA on natamycin efficacy on tomato leaves against
Botrytis after rain simulation. The data were measured 3 days
past inoculation. Presented is the efficacy compared to the water
control without natamycin PAA treatment. Letters indicate significant
difference among the treatments (P < 0.05) within each group.

| | |
|---|---|
| Natamycin:PAA | Dose rate natamycin (ppm) |

| ratio | 25 | 75 | 125 | 200 |
|---|---|---|---|---|
| 1:0 (no PAA) | 11.9 ± | 25.3 ± | 28.3 ± | 64.1 ± |
| | 1.4 a | 5.9 a | 4.6 ab | 3.2 b |
| 1000:1 (no vis. | 16.4 ± | 34.3 ± | 26.6 ± | 32.3 ± |
| inter.) | 2.9 a | 8.6 ab | 3.1 a | 6.0 a |
| 10:1 (vis. | 32.8 ± | 56.7 ± | 55.2 ± | b |
| interaction) | 7.5 b | 7.4 b | 3.2 b | |

Conclusion, the efficacy of complexes of natamycin+PAA is statistically significantly higher (at least two-fold higher) than that of natamycin without PAA or natamycin combined with PAA that does not form a complex (natamycin:PAA is 1000:1 or higher).

### Example 4. The Effect of the Polyelectrolyte PAA on Imidacloprid Behaviour in the Soil

Materials and Methods

Insecticides are often used to protect plant parts (eg roots) and seed in the soil. The efficacy of insecticides is limited by leaching of the insecticide from the soil towards the ground water layers. It was studied if imidacloprid complexed to PAA is retained more efficiently in the soil and thus increases the amount of insecticide in the root zone where insects attack the plant tissue or seeds.

Syringes with a volume of 100 ml (Omnifix syringes made of polypropylene, from B. BRAUN) were filled with 70 ml of a mixture of 10% garden soil and 90% of sand. The garden soil had a high content of fine organic matter. On top of the layer of organic matter in the syringe 5 ml of an imidacloprid formulation, containing 1 g of imidacloprid, either or not complexed with PAA, was added (See Table 10). The syringe was incubated vertically for 2 days at room temperature. The surface area of the syringe and the outlet of the syringe were left open to allow the soil material to settle. Hereafter, two batches of 25 ml water containing 0.01 M CaCl₂) (artificial rain) were added on top of the soil layer in each syringe. The second batch of the water coming out of the outlet of the syringe was collected (similar amounts of liquid could be collected from the second batch of water) and analyzed for imidacloprid content with HPLC.

In this HPLC system, a phenylhexyl 4.6×250 mm column (Ascentis®; MerckShimpack, Shimadzu) with pore size 5 um was used. Mobile phase was prepared with acetonitrile/water 90/10, flow rate 1 mL/min. The injection volume was 10 uL. The detector wavelength was 270 nm (the retention time is 3.3 min). Finally, the percentage of imidacloprid that was washed out of the soil was calculated. The experiment was performed in triplicate.

Results

Results are shown in Table 11.

TABLE 10
Composition of imidacloprid formulation.

| | Imidacloprid | Imidacloprid |
|---|---|---|
| | without PAA | complexed with PAA |
| | (%) | (%) |
| Imidacloprid | 12.7 | 12.7 |
| PAA (as 50% sol.) | 0.0 | 2.5 |
| Dispersant | 1-2 | 1-2 |
| Wetting agent | 1-2 | 1-2 |
| Antifoaming agent | 0.1-0.5 | 0.1-0.5 |
| Water | 82.8-85.2 | 80.3-82.7 |
| Total | 100.0 | 100.0 |

TABLE 11
Effect of complex formation of imidacloprid with PAA
on soil retention of imidacloprid. The percentage
of imidacloprid washed from the soil is presented.

| Imidacloprid:PAA | Imidacloprid washed | |
|---|---|---|
| ratio (w/w) | from the soil (%) | Significantly different |
| 1:0 (without PAA) | 11.1 | A |
| 10:1 | 8.9 | B |

Conclusion, a complex of imidacloprid and PAA results in a statistically significant improved soil retention of imidacloprid of about 20%.

### Example 5. Effect of Glyphosate-PAA Interaction on Herbicide Efficacy of Glyphosate on the Weeds Lolium perenne (Ryegrass) and Trifolium repens (Clover)

Materials and Methods

The efficacy of glyphosate is often sub-optimal because after drying of the glyphosate active ingredient on the plant tissue the rate of uptake is reduced (dry glyphosate is taken up poorly by the plant tissue). A complex of glyphosate-polycation with improved humectancy properties will remain longer as a wet film on the plant tissue, thereby enhancing uptake of glyphosate in the plant tissue and enhancing its herbicidal activity. In this experiment the effect of a formed complex on efficacy of glyphosate was assessed. The experiment was performed with hard water (500 ppm CaCO₃) and with soft water (50 ppm CaCO₃).

The following method was used. Seeds of rye grass and clover were sown in 2 L plastic pots (10 seeds pot) and grown in Lentse Potgrond (Horticoop; Bleiswijk, the Netherlands) in a greenhouse at 22° C. and at light 16 h and dark 8 h, humidity 75%. The experiment was carried out with 2 pots (replications) per treatment. The pots were watered as to keep the plants growing optimal. At the four-five leaf stage, when plants reached a height of 15-20 cm, they were sprayed with the glyphosate treatments with and without PAA (formulations: see Table 12). The spray was such that the plants were wetted completely and uniform. 12 days after the glyphosate treatments, the fresh weight and dry weight of the parts of the plants that were above ground were measured (grams). For dry weight, plants were first dried in an oven at 67 degree Celsius for 48 hours and weight was measured.

TABLE 12
Composition of glyphosate formulations.
NH3 is a 28% ammonia solution in water.

| | Glyphosate | Glyphosate with |
|---|---|---|
| Composition | without PAA (%) | PAA (%) |
| Glyphosate | 5 | 5 |
| PAA (50%) | 0 | 0.5 |
| Wetting agent | 1-5 | 1-5 |
| NH3 | 1-5 | 1-5 |
| Water | 85-93 | 84.5-92.5 |
| Total | 100.0 | 100.0 |

With the method described above rye grass plants were sprayed with two glyphosate formulations:
A. 2700 ppm glyphosate plus 270 ppm complexed with PAA at a 10:1 ratio (glyphosate:PAA; w/w) (formulation see Table 12).
B. 2700 ppm glyphosate without PAA (formulation, see Table 12).

Results

Results are shown in Tables 13, 14 and 15.

TABLE 13
The effect of complex formation with PAA on glyphosate
efficacy on the dry weight (in grams) of clover. The
average weight of the plants in each pot was determined
and the average of the two pots ± SE is presented.

| Water type (hard or soft) | Formulation A | Formulation B |
|---|---|---|
| Hard | 0.029 ± 0.001 a | 0.110 ± 0.022 b |
| Soft | 0.085 ± 0.005 a | 0.160 ± 0.004 b |

Conclusion: Complex formation with PAA increased the efficacy of glyphosate statistically significantly, leading to an extra reduction in dry weight of 74% for hard water and 47% for soft water.

TABLE 14
Effect of complex formation with PAA on glyphosate efficacy
in hard and soft water on the fresh weight (in grams) of
clover. The average weight of the plants in each pot was
determined and the average of the two pots ± SE is presented.

| Water type (hard or soft) | Formulation A | Formulation B |
|---|---|---|
| Hard | 0.187 ± 0.025 a | 0.302 ± 0.016 b |
| Soft | 0.221 ± 0.005 a | 0.397 ± 0.009 b |

Conclusion: Complex formation with PAA increased the efficacy of glyphosate statistically significantly, leading to an extra reduction in fresh weight of 38% for hard water and 44% for soft water.

TABLE 15
The effect of complex formation with PAA on glyphosate
efficacy on the dry weight (in grams) of rye grass. The
average weight of the plants in each pot was determined
and the average of the two pots ± SE is presented.

| Water type (hard or soft) | Formulation A | Formulation B |
|---|---|---|
| Hard | 0.123 ± 0.028 a | 0.280 ± 0.005 b |
| Soft | 0.366 ± 0.022 a | 0.684 ± 0.409 a |

Conclusion: Complex formation with PAA increased the efficacy of glyphosate statistically significantly, leading to an extra reduction in dry weight of 56% for hard water and 44% for soft water, and in dry weight of 48% for hard water and 46% for soft water.

### Example 6. Comparison of the Presented Method with the Method Described in WO2010/035118 for Production of Nanoparticles of 2,4-D Coated with Cationic Low Molecular Weight Chitosan Polymer

In this example, and the following examples, the method for production of a complex between the active ingredient 2,4-dichlorophenoxyacetic acid (2,4-D) and a polycation selected from chitosan, polyallylamine, or polyethyleneimine was compared with the methods known in the art, including in WO2010/035118, WO2005/065379, WO2008/002623 and US2013/045869.

To analyze the differences of the products produced by the different methods, a set of physical and chemical parameters was analyzed. In addition, the efficacy of the resulting products were compared in a bio-assay.

According to the method described in example 20 of WO2010/035118, 18 g of solid 2,4-Dichlorophenoxyacetic acid (2.4D) was dissolved in a beaker glass by using 10 N NaOH (8 ml). During the procedure the pH increased from 2.5 to about 7.6. In a different beaker glass, 32.9 g of solid low molecular weight chitosan (MW about 72 kD, calculated from example 20, assuming that 204 microM was used) was dispersed in 1062 ml water and 11 g of liquid acetic acid was added dropwise and the solution was stirred for 1 h until all solid chitosan was dissolved. Then, the aqueous 2,4-D solution was fed to the stirring chitosan using a feeding pump, the addition was completed in about 3.5 hours. The solution remained at room temperature overnight. Dynamic light scattering analyses by volume intensity distribution showed the mean diameter of the collapsed particles to be about 4 nm.

In the experiments described below, the 2,4-D solution was added dropwise to the chitosan solution with a graduated burette, over a period of 4 hours. A summary of the composition is given in Table 16.

For the present method, a complex with Low MW chitosan (MW between 50 and 190 kD) was produced with the salt of 2,4-D. In short: 2,4-D was dissolved by adding it to an aqueous solution containing diethanolamine (amounts as presented in the tables). During the procedure the pH increased to about 8. For the complex, the low molecular weight chitosan solution was prepared by dissolving chitosan in distilled water and by adding 1M HCl to reach pH between 4 and 4,5 for a complete dissolution of chitosan. The 2,4-D solution was then added within 5 minutes to the chitosan solution under stirring for 1 hour. The solution was left to rest for about 1 hour.

According to the present method, the ratio of polycation (chitosan) to active ingredient (AI) is preferably 1:5, while the ratio polycation to AI is about 2:1 in WO2010/035118. To demonstrate the importance of this difference, both methods were carried out using both ratios (details in Table 16). For this comparison in both methods 2,4-D salts were used.

TABLE 16
Composition of low MW chitosan with 2,4-D salt using the presented
method and the method described in WO2010/035118.

| | Method of | | | |
|---|---|---|---|---|
| | WO2010/035118 | | Presented Method | |
| | Ratio chitosan:2,4-D | | | |
| | 2:1 | 1:5 | 2:1 | 1:5 |
| | Mass [g] | Mass [g] | Mass [g] | Mass [g] |
| Chitosan low Mw | 32.9 | 3.7 | 32.9 | 3.7 |
| Diethanolamine | 0 | 0 | 9.5 | 9.5 |
| HCl 1M | 0 | 0 | 20 | 5 |
| 2.4D (100%) | 18 | 18 | 18 | 18 |
| NaOH 10N | 8 | 8 | 0 | 0 |
| Acetic acid | 11 | 2.2 | 0 | 0 |
| Water total | 2250 | 2250 | 2250 | 2250 |
| Total [g] | 2311.9 | 2330.4 | 2281.9 | 2282.7 |
| Concentration | 8 g/L | 8 g/L | 8 g/L | 8 g/L |
| 2,4-D | | | | |

Phys/Chem Analyses:

To measure the amount of 2.4-D entrapped/encapsulated in chitosan, the amount of non-entrapped/encapsulated 2,4-D levels was determined by HPLC. For this, first a calibration curve of 2,4-D, 7.8 mg/L-1000 mg/L was prepared. For all samples the concentration of 2,4-D was adjusted to 1000 mg/L via a dilution step in water. The mobile phase of the HPLC system (Shimatzu) was prepared with MeCN/H2O (40/60)+0.5 ml of Formic acid per Liter, pH 4 (NaOH). After filtration, the samples were loaded to a phenylhexyl HPLC column, 5 μm, 4.6×250 mm. For each sample, 10 microliter from the 1000 mg/L of 2,4-D solution was loaded onto the column. For analysis of the 2,4-D, absorbance at 230 nm was measured. The HPLC data demonstrate the amount of 2,4-D that is freely available in the solution, and that is not entrapped/encapsulated in a complex with chitosan. Results are presented in Table 17.

TABLE 17
Influence of the different ratios of chitosan/2,4-D on
the level (mg and percentages) of freely available (not
entrapped/encapsulated) 2,-4-D using low MW chitosan.

| | Method of ′118 | | Presented Method | |
|---|---|---|---|---|
| | Ratio chitosan:2,4-D | | | |
| | 2:1 | 1:5 | 2:1 | 1:5 |
| Concentration of | 96 mg/L | 432 mg/L | 151 mg/L | 524 mg/L |
| 2,4-D determined | | | | |
| Percentage of 2,4- | 90.4% | 56.8% | 84.9% | 47.6% |
| D entrapped | | | | |
| Percentage of 2,4- | 9.6% | 43.2% | 15.1% | 52.4% |
| D bio-available | | | | |

Conclusion: The method of combining a polycation and active ingredient, as well as the ratio of polycation to active ingredient are important for the entrapment and bio-availability of the active ingredient. When using the presented ratio (chitosan:2,4-D of 1:5), about half of the AI is not entrapped/encapsulated and readily available to act on the plants while the other half is entrapped in the complex insuring a longer lasting effect. In the case of a ratio chitosan:2,4-D of 2:1, most 2,4-D, (90 and 84% respectively) is entrapped/encapsulated. Also, accelerated addition of the active ingredient, as in the present method, resulted in more bioavailable active ingredient than when the active ingredient was slowly fed (15.1% versus 9.6% bioavaibility, respectively, for the 2:1 ratio). This was also demonstrated with the 1:5 ratio, where accelerated addition of the active ingredient led to 52.4% bioavaibility, whereas the slow feeding led to 43.2% bioavaibility.

Measurement of the particle size of low MW chitosan-2,4-D particles formed by using the presented ratio of 1:5 showed a volume-based average particle size of more than 3000 nm. This means that these particles were not collapsed, as described in WO2010/035118, but rather extended in the liquid solution. In contrast, the particle size of the collapsed particles formed via the method of WO2010/035118 is about 4 nm, as described in WO2010/035118, which is about 750-fold smaller. This shows that the differences in ratios of the polycation and AI are very important for the characteristics of the particles formed.

In order to have a good efficacy of the AI, it is advantageous for the complex of polycation/AI to have a good coverage of the targeted plant surface or surface of a plant part. The influence of the ratio polycation:AI on the spreading ability of the complex produced by the presented method and ratio was compared. To this end, per sample 4 drops of 10 microliter of 8 g/L 2,4-D complex were placed on a microscopic glass slide (horizontally placed). The surface area of the drops was measured after 1 hour (Table 18).

TABLE 18
Influence of the ratio of chitosan versus 2,4-D
on the ability of a drop to spread. The averaged
area of 4 drops ± SE after one hour is provided.

| | Present Method | | % increase in area |
|---|---|---|---|
| | Ratio chitosan:2,4-D | | coverage with |
| | 2:1 | 1:5 | present ratio |
| Surface area of a 10 ul | 29.6 mm² ± | 89.5 mm² ± | 202% |
| drop (mm²) | 0.79 | 2.50 | |

Conclusion: The ratio of polycation to active ingredient influenced the spreading of the solution. When using the present method and ratio, the ability to spread increased by 202%, compared to that of the ratio described in WO2010/035118.

Bio-Assay Results:

To assess the impact of the methods and ratio of polycation/AI on the herbicidal effect to plant tissue, the two samples obtained by the method of WO2010/035118 and the presented method were compared. The herbicidal effect was assessed on pods of snow pea. In a tray, a piece of absorbing paper was placed and humidified by adding 25 ml of water. The snow pea pods were washed under tap water and placed in the tray. The skin of the pods was damaged with a yarn needle with a diameter of 2 mm and to a depth of 3 mm into the pod. Per pods 3 wounds were made. On top of each wound 10 microliter of a chitosan-2,4-D complex of 8 g/L (see Table 16; complex was made by method of WO2010/035118, in both ratios of polycation:AI), was applied by pipetting. As control, 10 ul of water was pipetted. The tray was then closed with a transparent lid. All pods were kept at room temperature (20° C.). Wounds of the pods were checked after 24 h of incubation. To record the amount of herbicidal damage caused by the different complexes the surface area (square mm) of the damaged area around the wounds was measured. All treatments for the snow pea pod experiment were performed in nine-fold (3 pods with each 3 wounds). Results of the bioassay are presented in Table 19.

TABLE 19
Influence of the ratio chitosan/2,4-D on the herbicidal effect of
2,4-D on snow pea pods. The average of the damaged area of nine
observations is given. Measurements were done after 24 hours after
start of the 2,4-D applications. Data are presented ± SE.

| | Method of ′118 | | % of increased |
|---|---|---|---|
| | Ratio chitosan:2,4-D | | damage with present |
| | 2:1 | 1:5 | ratio of 1:5 |
| Herbicidal damage on | 19.1 mm² ± | 41.6 mm² ± | 118% |
| snow pea pods (mm²) | 2.69 | 5.89 | |

Conclusion: by using the presented methods and polycation-AI ratio, the herbicidal effect is more than twice that of using the method described in WO2010/035118, although the same amount of active ingredient was applied.

### Example 7. Comparison of the Presented Method and the Method Described in WO2010035118 for Production of Entrapped/Encapsulated 2,4-D Using Particles with High Molecular Weight Chitosan Polymer

According to the method described in example 22 of WO2010/035118: In a beaker glass, 8 g of solid 2,4-D was dissolved by adding 10 N NaOH. During the procedure the pH increased from 2.7 to 8.50. In a different beaker glass 14.6 g of solid high molecular weight chitosan (assuming that micromole was intended, instead of millimole) was dispersed in 1 Liter water, to which 4.89 g of liquid acetic acid was added dropwise and the solution was stirred for 2 h until all solid chitosan was dissolved. Then, the aqueous 2,4-D solution was fed to the stirring chitosan solution using a feeding pump. The final pH of the solution was 5.16. Dynamic light scattering analyzed by volume intensity distribution showed the mean diameter of the collapsed particles to be about 4 nm.

In the experiments presented below we did not use a feeding pump but added the 2,4-D solution to the chitosan solution dropwise with a graduated burette. A summary of the composition is given in Table 20.

For the present method, the complex with high MW chitosan instead of low MW chitosan was produced with the salt of 2,4-D, as described in Example 6 above. The only difference was the amount of the different components, details in Table 20. For each method, two ratios of polycation:AI were used, 1:5, and 2:1 (see Table

TABLE 20
Composition of high MW chitosan -2,4-D salt complexes
using the present method and the method described
in example 22 of WO2010/035118.

| | Method of ′118 | | Present Method | |
|---|---|---|---|---|
| | Ratio chitosan:2,4-D | | | |
| | 2:1 | 1:5 | 2:1 | 1:5 |
| | Mass [g] | Mass [g] | Mass [g] | Mass [g] |
| Chitosan High Mw | 14.6 | 1.6 | 14.6 | 1.6 |
| Diethanolamine | 0 | 0 | 6.6 | 6 |
| HCl 1M | 0 | 0 | 2 | 5 |
| 2.4D (100%) | 8 | 8 | 8 | 8 |
| NaOH 10N | 5 | 4 | 0 | 0 |
| Acetic acid | 4.89 | 1 | 0 | 0 |
| Water total | 2000 | 2000 | 2000 | 2000 |
| Total [g] | 2032 | 2015 | 2049 | 2019 |
| Concentration 2,4-D | 4 g/L | 4 g/L | 4 g/L | 4 g/L |

Phys/Chem Results:

HPLC and drop area measurements were performed as previously described (Example 6), with the only exception that for the drop assay, drops of 10 microliter of 4 g/L 2,4-D-chitosan samples were placed on a microscopic glass slides. The results are presented in tables 21 and 22.

TABLE 21
Influence of the different ratios of high mol weight chitosan:2,4-D
on entrapment/encapsulation and bio-availability of 2,-4-D.

Present Method
Ratio chitosan:2,4-D

| | 2:1 | 1:5 |
|---|---|---|
| Concentration of | 73 mg/L | 473 mg/L |
| 2,4-D measured | | |
| Percentage of 2,4- | 92.7% | 52.7% |
| D entrapped | | |
| Percentage of 2,4- | 7.3% | 47.3% |
| D bio-available | | |

Conclusion: The ratio of polycation to active ingredient is important for the entrapment and bio-availability of the active ingredient. When using the present ratio of 1:5 (chitosan:2,4-D) about half of the AI is not entrapped/encapsulated and readily available to act on the plants while the other half is entrapped in the complex insuring a longer lasting effect. In the case of the ratio of 2:1 (chitosan:2,4-D), as used in WO2010/035118, most 2,4-D, (92%) is entrapped/encapsulated.

TABLE 22
Influence of the ratio high molecular weight chitosan/2,4-D
on the ability of a drop to spread (measurement after 1
hour). The averaged area of 4 drops is provided, ± SE.

| | Present Method | | % of increased |
|---|---|---|---|
| | Ratio chitosan:2,4-D | | coverage with |
| High MW chitosan | 2:1 | 1:5 | present ratio |
| Surface area of a 10 ul | 48.3 mm² ± | 97.6 mm² ± | 102% |
| drop (mm²) | 1.57 | 1.88 | |

Conclusion: by using the present method and chitosan:2,4-D ratio the spreading of the complex is very different compared to using that of the ratio described in WO2010/035118: the area is increased more than two-fold.

Measurement of the particle size of high molecular weight chitosan-2,4-D particles formed by using the Ceradis ratio showed a volume particle size >1900 nm. This means that these particles were not collapsed, as described in WO2010/035118, but rather extended in the liquid solution. In contrast, the particle size of the collapsed particles formed via the method of WO2010/035118 is about 4 nm, as described in WO2010/035118, which is almost 500-fold smaller. This shows that the differences in ratios of the polycation and active ingredient are very important for the characteristics of the particles formed.

Bio-Assay Results:

To assess the impact of the ratio high molecular weight chitosan-2,4-D complex on the herbicidal effect (severity of tissue damage like necrosis, chlorosis and tissue collapse) to plant parts, the samples obtained based on the method of WO2010/035118, and ratios of 2:1 and 1:5 (chitosan:2,4-D) were used. The experiment was performed on snow pea as described in Example 6, with the difference that 10 microliter of the chitosan:2,4-D complexes at a concentration of 4 g/L were applied by pipetting. In addition, a second assay was performed using broad bean pods. The assay was performed as for the snow pea pods, with the following differences: Per broad bean pods 6 wounds were made. On each wound 10 microliter of the chitosan:2,4-D complexes at a concentration of 4 g/L were applied by pipetting. The numbers presented are averages of six wounds (Table 23).

TABLE 23
Influence of the ratio chitosan:2,4-D on the ability to cause
herbicidal damage on snow pea and broad bean pods. Measurements
were done after 24 hour after application, ± SE.

| | Method of ′118 | | % of increased |
|---|---|---|---|
| | Ratio chitosan:2,4-D | | damage by ratio |
| | 2:1 | 1:5 | of 1:5 |
| Damage on snow pea | 14.9 mm² ± | 23.9 mm² ± | 60% |
| pods (mm²) | 3.05 | 6.76 | |
| Damage on broad bean | 6.8 mm² ± | 10.7 mm² ± | 57% |
| pods (mm²) | 0.35 | 1.02 | |

Conclusion: by using the present polycation-AI ratio of 1:5, the herbicidal effect is more than twice than by using the complex described in WO2010/035118.

### Example 8. Comparison of the Present Method and Method Described in WO2010035118 for Production of Polyallylamine-2,4-D Particles

A summary of the method described in example 18 of WO2010035118: In a glass beaker, 0.158 g of solid 2,4-D was added to 50 ml of deionized water. Under continuous stirring, aqueous NaOH (ION) was added dropwise. During the procedure the pH increased from 2.7 to 10.7. In a different beaker glass solid 0.5 g of poly(allylamine) (PAA) and 50 mL of deionized water were added. Then, the aqueous 2,4-D solution was fed to the stirring PAA solution via a feeding pump. The final pH of the solution was 4.7. Dynamic light scattering analyzed by volume intensity distribution showed the mean diameter of the collapsed particles to be about 7 nm.

In the experiments presented below we did not use a feeding pump but added the 2,4-D solution into the PAA solution dropwise with a graduated burette. Summary of the composition is given in Table 24.

For the present method, the complex with PAA instead of low MW chitosan was produced with the salt of 2,4-D, as described in Example 6. For each method, two ratios of polyallylamine-2,4-D were used, the present one of 1:5, and that described in the method of WO2010035118 (2:1).

TABLE 24
Composition of polyallylamine- 2,4-D salt using the present
method and the method described in WO2010035118.

| | Method of ′118. | | Present Method | |
|---|---|---|---|---|
| | Ratio PE:Al | | | |
| | 2:1 | 1:5 | 2:1 | 1:5 |
| | Mass [g] | Mass [g] | Mass [g] | Mass [g] |
| PAA | 0.5 | 0.031 | 0.5 | 0.031 |
| Diethanolamine | 0 | 0 | 0.3 | 0.28 |
| HCl 1M | 0 | 0 | 0 | 0 |
| 2.4D (100%) | 0.158 | 0.158 | 0.158 | 0.158 |
| NaOH 10N | 0.1 | 0.1 | 0 | 0 |
| Acetic acid | 0 | 0 | 0 | 0 |
| Water total | 100 | 100 | 100 | 100 |
| Total [g] | 100.8 | 100.3 | 100.9 | 100.5 |
| Concentration | 1.58 g/L | 1.58 g/L | 1.58 g/L | 1.58 g/L |
| 2,4-D | | | | |

Phys/Chem Results:

The complexes obtained with the method of WO2010035118, with both ratios of 2:1 and 1:5 (PAA:AI) were tested for humectancy. For this, the test was performed as described in Example 2. For each sample, the test was carried in triplicate. The final measurements for the humectancy was carried out 7 days after incubation in a box with 97% relative humidity. The results of the humectancy assay are provided in Table 25.

TABLE 25
Effect of the ratio PAA:2,4-D on humectancy, ± SE.

| | Method of ′118 | | % of increased |
|---|---|---|---|
| | Ratio PAA:2,4-D | | humectancy with |
| PAA | 2:1 | 1:5 | present ratio |
| Humectancy (%) | 287.1% ± 19.6 | 348.9% ± 10.8 | 22% |

Conclusion: polyallylamine-2,4-D particles produced with a ratio of 1:5 (PAA:AI) bound more water and thus acted as a stronger humectant, compared to particles produced with a ratio of 2:1, as described in WO2010035118. The difference in humectancy shows that the different ratios have an impact on the phys/chem properties.

To test the ratio effect on the spreading of the complexes on a glass slide, a test as described in Example 6 was performed, with the exception that 10 microliters drops at concentration of 1.58 g/L polyallylamine-2,4-D were pipetted on glass slides. Results of the drop assay are given in Table 26

TABLE 26
Influence of the ratio PAA:2,4-D on the ability of a drop
to spread. The averaged area of 4 drops is given, ± SE.

| | Present Method | | % of increased |
|---|---|---|---|
| | Ratio PAA:2,4-D | | coverage with |
| PAA | 2:1 | 1:5 | ratio of 1:5 |
| Surface area of a 10 ul drop | 62.7 mm² ± | 73.2 mm² ± | 17% |
| (mm²) | 1.39 | 3.47 | |

By using the present method and chitosan:2,4-D ratio, the spreading of the solution is increased, when compared to a ratio as described in WO2010035118: the area is 17% higher.

Measurement of the particle size of polyallylamine-2,4-D particles formed by using the present ratio showed a volume-based, average particle size of 300 nm. This means that these particles were not collapsed but rather extended in the liquid solution. In contrast, the particle size of the collapsed particles formed via the method of WO2010035118 is 7 nm (see WO2010035118), which is 43-fold smaller. This shows that the differences in ratios of the polycation and active ingredient are very important for the characteristics of the particles formed.

Bio-Assay Results:

To assess the impact of the ratio PAA:2,4-D on the amount of damage to plant parts, two samples obtained based on the method described in WO2010035118 having a ratio of 2:1 (Polycation:AI) and a ratio of 1:5 (Polycation:AI) were used. The experiment was performed on broad bean pod as described in Example 7, with the difference that 10 microliter of the complexes at a concentration of 1.58 g/L were applied by pipetting on the wounds. The six wounds were used as replicates (Table 27).

TABLE 27
Influence of the ratio PAA:2,4-D on the ability to cause damage
on broad bean pods. The average of the damaged area of 6 wounds
is given. Measurements were done after 1 day, ± SE.

| | Method of ′118 | | % of increased |
|---|---|---|---|
| | Ratio PAA:2,4-D | | damage with ratio |
| PAA | 2:1 | 1:5 | of 1:5 |
| Damage on broad bean | 9.1 mm² ± | 10.8 mm² ± | 19% |
| pods (mm²) | 1.32 | 1.17 | |

Conclusion: by using the method described in WO2010035118, and a ratio of 1:5 (polycation-AI), as described herein, the herbicidal effect is about 19% higher than using a ratio of 2:1 as described in WO2010035118.

### Example 9. Comparison of the Present Method with the Method Described in WO2008002623 for Production of Formulations of Water Soluble, Negatively Charged Pesticides

WO2008/002623 described, with hypothetical examples, the use of polycations and a pesticide. In Examples 26 and 29, chitosan is mentioned. However, in these examples chitosan is chemically modified to increase the number of charged groups by reaction with epichlorohydrin and polyethyleneimine to form covalent links to a polymer network. In this procedure chitosan is treated under extreme pH conditions (concentrated NaOH) and at high temperature (90° C.). Also, the chemically modified chitosan is washed with different solvents. After these procedures the characteristics of chemically modified chitosan will differ from unmodified chitosan.

In the present method only dissolved chitosan in acidified water is used, and the active ingredient added to the water/polycation mixture. In Example 15 of WO2008/002623, a method that is most close to the present method is described, where polyethyleneimine is used instead of chitosan or polyallylamine.

A summary of the method used in Example 15 of WO2008002623: 10 mL of polyethyleneimine 50% V/V (PEI, normally diluted with at least 10 mL water) are mixed with 2,4-D at an exchange equivalent amount of 7.15 g glyphosate free acid (MW 169). To the best of our knowledge, this corresponds to 9.3 g of 2,4-D acid. The PEI and 2,4-D were mixed with a magnetic stirrer with heating. Since no indications are given on the temperature and duration for the heating, samples were heated to 50° C. and for 30 minutes. The pH was monitored and adjusted to 5.5. Summary of the composition is given in Table 28.

For the present method, the complex of PEI and 2,4-D salt was generated as described in Example 6. In short: the solid 2,4-D free acid was dissolved in diethanolamine to produce 2,4-D salt (See Table 28). In a glass beaker, the PEI was dispersed in water. Then the 2,4-D solution was added to the PEI solution under stirring. The pH was adjusted to 5.5.

As is indicated herein above, the ratio of polycation to active ingredient is preferably 1:5, while in Example 15 of WO2008002623, a ratio of 1:1.9 (PEI:2,4-D) was used. To compare the different methods, both methods were used to prepare the complexes at both the 1:5 and 1:1.9 ratios. Details of the compositions are given in Table 28.

TABLE 28
Composition of PEI with 2,4-D using the
Ceradis method and the Hi-Cap method.

| | Method | Present | Method | Present |
|---|---|---|---|---|
| | of ′623 | Method | of ′623 | Method |
| | Ratio PEI:2,4-D | | | |
| | 1:1.9 | 1:1.9 | 1:5 | 1:5 |
| | Type Al | | | |
| | Acid | Salt | Acid | Salt |
| | Mass [g] | Mass [g] | Mass [g] | Mass [g] |
| PEI (50%) | 10 | 10 | 3.8 | 3.72 |
| Diethanolamine | 0 | 4.4 | 0 | 4.42 |
| 2.4-D (100%) | 9.3 | 9.5 | 9.5 | 9.3 |
| Water total | 10 | 5.6 | 16.2 | 11.86 |
| Heating on | 50° C., | No | 50° C., | No |
| magnetic stirrer | 30 min | | 30 min | |
| Concentration | 31.7% | 31.7% | 31.7% | 31.7% |
| 2,4-D (%) | | | | |

Phys/Chem Results:

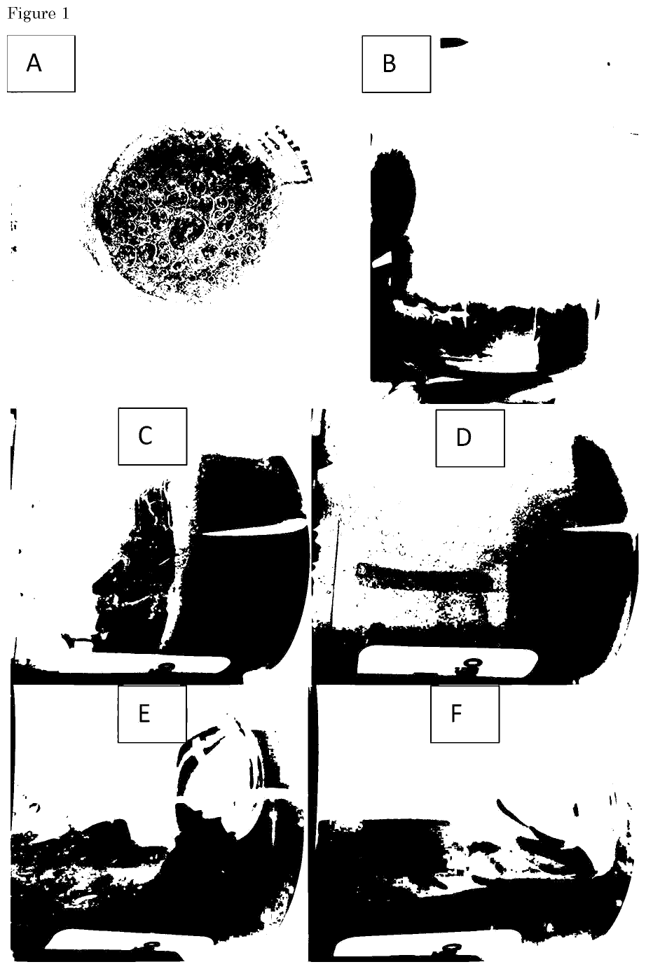

When preparing the samples based on the method of WO2008002623 and a ratio of 1:1.9 (PEI:2,4-D), as presented in the example 15 of patent WO2008002623, a yellow turbid complex was formed with a phase separation. Because the sample separated, the measurement of viscosity was unreliable. In addition, when trying to produce a complex according to the method of WO2008002623 and using the a ratio of PEI: 2,4-D of 1:5, an unworkable sticky mass was produced (see FIG. 1, A and B). In contrast, when preparing with the present method with both ratios, a yellow gel and yellow viscous liquid was obtained and no difficulties were encountered in further usage of the product formed (Table 29).

TABLE 29
Appearance and viscosity of the PEI:2,4-D complex

| | Method | Present | Method | Present |
|---|---|---|---|---|
| | of ′623 | Method | of ′623 | Method |
| | Ratio PEI:2,4-D | | | |
| | 1:1.9 | 1:1.9 | 1:5 | 1:5 |
| | Type Al | | | |
| | Acid | Salt | Acid | Salt |
| Appearance | Yellow, turbid | Yellow gel | Thick paste, | Yellow |
| | phase | | Impossible | viscous |
| | separation | | to work with | liquid |
| Viscosity | —¹ | 4000 | NA | 100 |
| Brookefield | | | | |
| Spindle S64 | | | | |
| (mPas) 12 | | | | |
| RPM/60 RPM | | | | |

¹data unreliable due to the different phases of the sample. NNA: not possible to analyze.

Because of the poor properties of the products obtained with the method described in WO2008002623, we were not able to analyse these products in bioassays.

### Example 10. Preparation of a 2,4-D-PEI Complex in Water and Formulation into Emusifiable Concentrates and Aqueous Suspension

In patent application US20130045869A1, complexes of herbicidal carboxylic acids and amine-containing polymers or oligomers are provided. The method described in US20130045869A1 results in emulsifiable concentrates. Furthermore, in US20130045869A1 solvents such as methanol, ethanol, ethylene glycol, and propylene glycol (see § [0027] of US20130045869A1), are used in general to prepare the complex of polyethyleneimine and a herbicidal active ingredient. In the present methods, no such organic, alcoholic, water miscible, low boiling point solvents are used for complex formation and no emulsifiable concentrates are produced.

The example described in Method B, sample 10 of US20130045869A1 comes closest to the method described herein and the products produced via this method are compared to products generated by the present method.

As a summary of method B described to generate Sample 10 of US20130045869A1: In a glass beaker, 200 g of 25% w/w polyethyleneimine (PEI) solution in water was produced by diluting the product Lupasol® G20 (a commercial PEI product) in water. Under rigorous agitation, 149.94 g of 2,4-D acid was slowly added into the 25% PEI solution. The resulting mixture was stirred until all solid particles dissolved (about 6 hours). Hereafter, the mixture was allowed to stand for one day. The end-sample was used to formulate the final product (sample 11) of Method B as described in US20130045869A. The formulation of the sample (Method B, sample 11) was as follows: 30 g of the PEI-2,4-D complex was mixed with 9 g of Dowanol® G20 (a commercial ethylene glycol butyl ether product), 4.6 g of Atlas™ G5000, and 2.3 g of Atlox™ 4914. The 2,4-D PEI complex contained about 27.8% of 2,4-D.

In the experiments below we used the compounds PEI mixed with water (50% solution) instead of Lupasol® and ethylene glycol butyl ether was used instead of Dowanol™. Details of the composition are given in Table 30.

For the present method, a complex with PEI was produced with the salt of 2,4-D. In short: 2,4-D was dissolved by adding it to an aqueous solution containing diethanolamine (amounts as presented in Table 30). For the complex, the PEI solution was prepared by dissolving PEI in distilled water. Then the 2,4-D solution was added to the PEI solution under stirring for 1 hour. The solution was left to rest for 1 day. Details of the composition is provided in Table 30.

In the present method, the ratio of PEI to 2,4-D is preferably 1:5, while in US20130045869A1, the ratio of PEI to 2,4-D is 1:3. To compare the different methods, both methods were used, with both ratios. Details of the compositions are given in Table 30. In addition, to compare the complexes produced by the different methods, 30 g of the complexes produced by the present methods were also formulated with 9 g of Ethylene glycol butyl ether, 4.6 g of Atlas™ G5000, and 2.3 g of Atlox™ 4914. The amount of 2,4-D was 27.8% in each of the formulations.

TABLE 30
Composition of PEI - 2,4-D complex using the present
method and the method described in US20130045869A.

| | Method | Present | Method | Present |
|---|---|---|---|---|
| | of ′869 | Method | of ′869 | Method |
| | Ratio PEI:2,4-D | | | |
| | 1:3 | 1:3 | 1:5 | 1:5 |
| | Type Al | | | |
| | Acid | Salt | Acid | Salt |
| | Mass [g] | Mass [g] | Mass [g] | Mass [g] |
| PEI (50%) | 100 | 100 | 60 | 60 |
| Diethanolamine | 0 | 71.26 | 0 | 71.26 |
| 2.4-D (100%) | 149.94 | 149.94 | 149.94 | 149.94 |
| Water | 103.4 | 32.1 | 142.9 | 71.6 |

Phys/Chem Results:

The preparation of the samples using the method of US20130045869 and a ratio of 1:3 (PEI: 2,4-D) resulted in a highly viscous to paste like blend which could hardly be stirred. After preparing the complex of PEI-2,4-D, this was followed by 1 day of standing time as described in US20130045869 to achieve of separation of water. The expected separation of the aqueous phase on top and amber 2,4-D-PEI complex on bottom was not observed, it was more a foamy gel in the top. In addition, when using the method of US20130045869 with a ratio of 1:5 (PEI: 2,4-D), a highly viscous complex was also obtained. For the present method however, independently of the ratio, a clear flowable liquid was obtained (Table 31, FIG. 1, C-F).

TABLE 31
Visual and physical observations when comparing
the Dow and Ceradis PEI-2,4-D complexes.

| | Method | Present | Method | Present |
|---|---|---|---|---|
| | of ′869 | Method | of ′869 | Method |
| | Ratio PEI:2,4-D | | | |
| | 1:3 | 1:3 | 1:5 | 1:5 |
| | Type Al | | | |
| PEI | Acid | Salt | Acid | Salt |
| Appearance | Highly | Clear | Highly viscous, | Clear |
| | viscous turbid | flowable | nearly solid | flowable |
| | paste, brown | liquid, | brown to amber | liquid, |
| | to amber | brown | mass | brown |

The four complexes were formulated as described in US20130045869A1 using ethylene glycol butyl ether, Atlas™ G5000, and Atlox™ 4914. The formulation of the samples using this method were more difficult than when produced with the present method (Table 32). Further the viscosity was measured and clearly the samples produced with the method of US20130045869 were more viscous (Table 32). Finally, as described in US20130045869A1, once formulated the samples are ready to be use as a spray application upon dilution to water. To this end, the four formulated complexes were diluted into water in a 2 milliliters Eppendorff cup to reach a concentration of 8 g/L of 2,4-D. In the case of the samples produced with the method of US20130045869, it was more difficult to fully dissolve the formulated complexes, as is clear from the required number of tube inversions. In clear contrast this was not the case for the samples obtained by the present method (Table 32).

TABLE 32
Visual observations and viscosity results after formulation
of the PEI complexes using ethylene glycol butyl
ether, AtlasTM G5000 and AtloxTM 4914.

| | Method | Present | Method | Present |
|---|---|---|---|---|
| | of ′869 | Method | of ′869 | Method |
| | Ratio PEI:2,4-D | | | |
| | 1:3 | 1:3 | 1:5 | 1:5 |
| | Type Al | | | |
| | Acid | Salt | Acid | Salt |
| Appearance formulated | Turbid | Turbid | Turbid | Turbid |
| complexes | brown | brown | brown | brown |
| | solution | solution | solution | solution |
| Viscosity Brookefield | 6400/ | 2900/ | 16500/ | 700- |
| Spindle S64 (mPas) at | 6130 | 2879 | out of | 1000/ |
| 12 RPM/60 RPM | | | measuring | 670 |
| | | | range | |
| Mixability in water | 286 tube | 7 tube | 467 tube | 5 tube |
| for spray solution | inversions | inversions | inversions | inversions |
| (8 g/l 2,4-D) | | | | |

Finally, the four formulated samples were tested for humectancy as described in Example 2. For each sample, the test was carried in triplicate. The final measurements for the humectancy was carried out 7 days after incubation in the box with 97% relative humidity. The results of the humectancy assay are given in Table 33.

TABLE 33
Influence of the different methods on the humectancy,
± SE of the formulated complexes.

| | Method of | Present | Method of | Present |
|---|---|---|---|---|
| | ′869 | Method | ′869 | Method |
| | Ratio PEI:2,4-D | | | |
| | 1:3 | 1:3 | 1:5 | 1:5 |
| | Type Al | | | |
| PEI | Acid | Salt | Acid | Salt |
| Humectancy | 125.76% ± | 170.6% ± | 114.4% ± | 181.3% ± |
| | 0.85 | 2.29 | 0.69 | 2.88 |

The data in Table 33 show that the present method provide an increased humectancy to the PEI:AI complexes for both rations of PEI:AI. In the case of a 1:3 ratio, the formulated product using the present method showed a 45% increase in humectancy compared to the sample prepared by the method described in US20130045869A1. In the case of a 1:5 ratio, the formulated product using the present method showed a 67% increase in humectancy compared to the sample prepared by the method described in US20130045869A1.

Conclusion from the physical/chemical analyses: in both non-formulated and formulated samples prepared by the two methods for complexing 2,4-D to PEI, products with largely different physical/chemical properties were formed (appearance, viscosity, dissolving properties of formulated product, and humectancy properties). The data show that via the two methods different interactions between the 2,4-D and the PEI occur.

In the previous tests within this example, the complexes were formulated with ethylene glycol butyl ether, Atlas G5000 and Atlox 4914. According to the present invention, once a complex is formed it can be used directly to produce a stable aqueous suspension. Thus the complexes of 2,4-D-PEI as described in Table 30, were dissolved in water to reach a concentration of 27.8% of 2,4-D. In other words instead of formulating as described in US20130045869A1 (Method B, sample 11), the complexes were dissolved in water to an equal concentration as that of the earlier formulated samples. The results of this dissolution are shown in Table 34.

TABLE 34
Appearance of the PEI-2,4-D complexes
of Dow and Ceradis when added in water.

| | |
|---|---|
| Method of ′869 | Present Method |

Ratio PEI:2,4-D

| | |
|---|---|
| 1:3 | 1:3 |

Type Al

| PEI | Acid | Salt |
|---|---|---|
| Complex PEI:2,4-D | Highly viscous | Clear flowable |
| | turbid paste | liquid |
| Dissolution in water | Impossible | Clear flowable |
| 27.8% 2,4-D) | | liquid, light yellow |

Conclusion: While a complex generated by the present methods could be dissolved in water, clearly a complex generated by the method of US20130045869A1 did not. Instead, a very sticky mass was produced that covered the mechanic stirrer and was very difficult to clean afterwards. This demonstrates that in the case of the methods of US20130045869A1, a solvent is required either during the step of complex formation (Methods A, C, D and E) or during the step of formulation of the complex as it is the case in the Method B.

HPLC measurements were performed as described in Example 6. The results are presented in Table 35. In the case of a formulated complex produced according to the method of US20130045869A1, ethylene glycol butyl ether, Atlas G5000 and Atlox 4914 were added, while in the case of a sample according to the present method, the complex was diluted in water only (see row marked as “Spray solution in water” in Table 36).

TABLE 35
Influence of the different methods on the entrapment
and bio-availability of 2,-4-D, using PEI.

| | Method of ′869 | Present Method |
|---|---|---|
| | Ratio PEI:2,4-D | |
| PEI | 1:3 | 1:3 |
| Concentration of 2,4-D measured | 8.9 mg/L | 826 mg/L |
| Percentage of 2,4-D entrapped | 99.11% | 17.4% |
| Percentage of 2,4-D bio-available | 0.89% | 82.6% |

Conclusion: the entrapment/encapsulation (complexation) in the two products result to different amounts of 2,4-D that is complexed.

Bio-Assay Results:

The bio-activity of the formulated complex of PEI-2,4-D as described in US20130045869A1 was compared with a complex generated according to the present method as described in Table 33 and diluted in water. For this, a bio-assay was performed using broad beans as described in Example 7. The formulated sample according to US20130045869A1 was diluted in water to a concentration of 8 g/L, and the a complex generated according to the present method was diluted in water to the same concentration. On the wounds of the broad bean pods, 10 microliter of each samples were pipetted. The six wounds were used as replicates, results are given in Table 36.

TABLE 36
Influence of the Dow and Ceradis methods using PEI and 2,4-D
on the ability to cause herbicidal activity on broad bean pods.
The average of the damaged area of 6 wounds is given. Measurements
were done after 3 days. Data ± SE are presented.

| | Method | Present | |
|---|---|---|---|
| | of ′869 | Method | |
| | Ratio PEI:2,4-D | | |
| | 1:3 | 1:3 | |
| | Type Al | | |
| | Acid | Salt | |
| | Formulated in | | |
| | Ethylene glycol | | % of |
| | butyl ether, | | increased |
| | Atlas G5000 | | coverage |
| | and Atlox 4914 | Water | with |
| | Spray solution in water | | present |
| PEI | 8 g/L 2,4-D | 8 g/L 2,4-D | method |
| Herbicidal activity on | 17.9 mm² ± | 21.7 mm² ± | 21% |
| broad bean pods (mm²) | 1.14 | 2.04 | |

Conclusion: also the bio-results (herbicidal efficacy) are different for products produced by the method of US20130045869A1 and the present method. The present method showed a 21% increase in efficacy of the complexed 2,4-D.

1. A composition comprising a complex between a polycation and a negatively charged bioactive ingredient, said complex comprising the polycation and bioactive ingredient in a relative amount of between 1:1 and 1:20. having an average particle size of between 100 nanometers and 20 micrometers.

2. The composition of claim 1, wherein the bioactive ingredient is a fungicide and/or a pesticide.

3. The composition of claim 1, wherein the polycation is selected from polyallylamine and chitosan.

4. The composition of claim 1, wherein the bioactive ingredient is selected from 2,4D, dicamba, pelargonic acid, imidacloprid, clothianidin, Fosetyl Al, glyphosate, natamycin, and phosphonate salts.

5. The composition of claim 1, comprising an additional bioactive ingredient, preferably a fungicide and/or a herbicide.

6. The composition of claim 1, further comprising an agriculturally acceptable carrier.

7. A method for producing a composition according to claim 1, comprising (a) providing an aqueous composition of a polycation,
(b) quickly adding a bioactive ingredient to the aqueous composition of a polycation, while keeping the pH of the mixture below pH=5.5, preferably below 4.5, by addition of an acid, mixing, and, optionally,
(c) adding an additional bioactive ingredient biocide to at least one of the previous steps.

8.-9. (canceled)

10. A method of protecting a plant, or a part of a plant, against a pathogen, comprising
contacting said plant, or part of said plant, with a composition according to claim 1.

11. A method of preventing, reducing and/or eliminating the presence of a pathogen on a plant, or a part of a plant, comprising
contacting said plant, or part of said plant, with a composition according to claim 1, thereby preventing, reducing and/or eliminating the presence of a pathogen on a plant, or a part of a plant.

12. The method of claim 10, wherein the part of a plant is seed or fruit.

13. A method of controlling diseases caused by a phytopathogen, comprising contacting a plant, or a propagation material thereof, with a composition according to claim 1, thereby controlling diseases caused by a phytopathogen.

14. A method for preventing development of soilborne pathogens in or on a soil comprising
(a) providing a composition according to claim 1; and
(b) adding the composition to the soil.

15. The invention further provides a method for preventing development of a pest or weed in or on a soil, comprising
(a) providing a composition according to the invention; and
(b) adding the composition to the soil, thereby preventing development of a pest or weed in or on the soil.

16. The method of claim 11, wherein the part of a plant is seed or fruit.
